(19) United States
(12) Patent Application Publication
(10) Pub. No.: US 2025/0108469 A1
(43) Pub. Date: Apr. 3, 2025

(54) APPARATUS, SYSTEMS AND METHODS FOR MACHINING A MOVING WEB OF ELECTRODE MATERIAL

(71) Applicant: Enovix Corporation, Fremont, CA (US)

(72) Inventors: Michael T. Andres, Milpitas, CA (US); Ross Popescu, Vancouver, WA (US); Dhruv Bhalla, Vancouver (CA); Ashton Rust, Alamo, CA (US); Nicholas J. Kowalczyk, San Francisco, CA (US); Robert S. Busacca, San Francisco, CA (US)

(21) Appl. No.: 18/899,423

(22) Filed: Sep. 27, 2024

Related U.S. Application Data
(60) Provisional application No. 63/586,234, filed on Sep. 28, 2023.

(51) Int. Cl. B24B 7/12; H01M 4/74

(52) U.S. Cl. CPC B24B 7/12; H01M 4/747

(57) ABSTRACT

An apparatus for machining a web made of electrode material includes a track extending continuously between a web path and an offload path, and supports operatively coupled to the track and moveable continuously along the web path and the offload path. The track is operable to control a conveying speed of each support along the web path. Each support includes a work surface that engages with the web at a first end of the web path to convey the web in the down-web direction at the conveying speed along the web path between the first end and a second end of the web path. The web is disengaged from the work surface at the second end of the web path. The apparatus also includes a machining device operable to act on the web as the web is conveyed in the down-web direction at the conveying speed along the web path.

### CROSS-REFERENCE TO RELATED APPLICATION

This application claims benefit of U.S. Provisional Patent Application Ser. No. 63/586,234 filed on Sep. 28, 2023, which is hereby incorporated by reference herein in its entirety.

### FIELD

The field of this disclosure relates generally to energy storage technology, such as battery technology. More specifically, the field of this disclosure relates to systems and methods for the production of energy storage systems, such as electrodes for use in batteries, including lithium based batteries.

### BACKGROUND

Lithium based secondary batteries have become desirable energy sources due to their comparatively high energy density, power and shelf life. Examples of lithium secondary batteries include non-aqueous batteries such as lithium-ion and lithium-polymer batteries.

Known energy storage devices, such as batteries, fuel cells and electrochemical capacitors, typically have two-dimensional laminar architectures, such as planar or spirally wound (i.e., jellyroll) laminate structures, where a surface area of each laminate is approximately equal to its geometric footprint (ignoring porosity and surface roughness).

FIG. 1 illustrates a cross-sectional view of a known laminar type secondary battery, indicated generally at 10. The battery 10 includes a positive electrode current collector 15 in contact with a positive electrode 20. A negative electrode 25 is separated from the positive electrode 20 by a separator layer 30. The negative electrode 25 is in contact with a negative electrode current collector 35. As shown in FIG. 1, the battery 10 is formed in a stack. The stack is sometimes covered with another separator layer (not shown) above the negative electrode current collector 35, and then rolled and placed into a can (not shown) to assemble the battery 10. During a charging process, a carrier ion (typically, lithium) leaves the positive electrode 20 and travels through the separator layer 30 into the negative electrode 25. Depending upon the anode material used, the carrier ion either intercalates (e.g., sits in a matrix of negative electrode 25 material without forming an alloy) or forms an alloy with the negative electrode 25 material. During a discharge process, the carrier ion leaves the negative electrode 25 and travels back through the separator layer 30 and back into the positive electrode 20.

Three-dimensional secondary batteries may provide increased capacity and longevity compared to laminar secondary batteries. The production of such three-dimensional secondary batteries, however, presents manufacturing and cost challenges. Precision manufacturing techniques used, to-date, can yield secondary batteries having improved cycle life but at the expense of productivity and cost of manufacturing. When known manufacturing techniques are sped up, however, an increased number of defects, loss of capacity and reduced longevity of the batteries can result.

### BRIEF DESCRIPTION

One aspect is an apparatus for machining a web made of electrode material, the web having a down-web direction and a cross-web direction, the down-web and cross-web directions being orthogonal to each other. The apparatus includes a track defining a web path and an offload path, the track extending continuously between the web path and the offload path, and a plurality of supports operatively coupled to the track and moveable continuously along the web path and the offload path. The track is operable to control a conveying speed of each support of the plurality of supports along the web path. Each support includes a work surface that engages with the web at a first end of the web path to convey the web in the down-web direction at the conveying speed along the web path between the first end and a second end of the web path. The web is disengaged from the work surface at the second end of the web path. The apparatus also includes a machining device located between the first end and the second end of the web path. The machining device is operable to act on the web as the web is conveyed in the down-web direction at the conveying speed along the web path.

Another aspect is an apparatus for machining a web made of electrode material, the web having a down-web direction and a cross-web direction, the down-web and cross-web directions being orthogonal to each other. The apparatus includes a track defining a web path extending in the down-web direction between a first end and a second end, and a work platform operably coupled to the track. The work platform extends between the first and second ends of the web path. The track is operable to continuously move the work platform from the first end of the web path to the second end of the web path at a conveying speed. The work platform engages with the web at the first end of the web path and disengages from the work surface at the second end of the web path to convey the web along the web path at the conveying speed. The apparatus also includes a machining device located between the first and second ends of the web path, the machining device being operable to act on the web as the web is conveyed at the conveying speed along the web path, and a vacuum chute to remove debris from the continuously moving work platform.

Another aspect is a process for machining a web made of electrode material. The process includes moving the web in a down-web direction at a conveying speed; controlling a work platform extending between first and second ends of a web path to move continuously at the conveying speed from the first end of the web path to the second end of the web path; engaging the continuously moving work platform with the moving web at the first end of the web path; machining the moving web at a machining location between the first and second ends of the web path; removing debris from the moving work platform at or downstream from the machining location; and disengaging the moving web from the moving work platform at the second end of the web path.

Various refinements exist of the features noted in relation to the above-mentioned aspects. Further features may also be incorporated in the above-mentioned aspects. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a cross-section of an existing laminar battery.

FIG. 2 is a schematic diagram of one suitable embodiment of an electrode manufacturing system according to the present disclosure.

FIG. 3 is an enlarged schematic view of one suitable embodiment of a laser system according to the present disclosure.

FIG. 4 is an isometric view of a stationary chuck that may be used in a cutting assembly with the laser system of FIG. 3.

FIG. 5 is a truncated top view of example webs of base material formed into electrodes after having been processed through the electrode manufacturing system of the current disclosure.

FIG. 6 is a top view of an example web of base material having electrode patterns formed thereon.

FIG. 6A is a perspective view of a portion of the web of base material as an example negative electrode.

FIG. 6B is a perspective view of a portion of the web of base material as an example positive electrode.

FIG. 7 is an enlarged top view of a portion of a web of base material having an example electrode pattern formed thereon.

FIG. 8 is an isometric view of base material formed into a web of electrode material including electrode patterns after having been processed through the electrode manufacturing system of the current disclosure.

FIG. 8A is a top view of a portion of the web of electrode material of FIG. 8.

FIG. 9 is an isometric view of one suitable embodiment of a rewind roller of the electrode manufacturing system of the current disclosure.

FIG. 10 is a top view of one suitable embodiment of a brushing station of the current disclosure.

FIG. 11 is a side view of the example brushing station shown in FIG. 10.

FIG. 12 is an isometric view of one suitable embodiment of an inspection station according to the current disclosure.

FIG. 13 is a top view of a chuck according to one suitable embodiment of the current disclosure.

FIG. 14 is a schematic view of a stacking arrangement according to the current disclosure.

FIG. 15 is a cross section of a multi-layer stack of electrodes according to the current disclosure.

FIG. 16A is a side view of a multi-layer stack of electrodes according to the current disclosure.

FIG. 16B is a partial top view of the multi-layer stack of electrodes of FIG. 16A.

FIG. 16C is a partial top view of the multi-layer stack of FIG. 16A after rupture of a second perforation.

FIG. 17 is an isometric view of a stacked cell according to the current disclosure.

FIGS. 18A and 18B are sequential isometric views of a stacked cell having a battery package placed thereon.

FIG. 19 is a schematic view of a portion of a web of electrode material processed in the electrode manufacturing system of FIG. 2, showing differently conditioned segments of the web during production.

FIG. 20 is a schematic view of an example machining apparatus used in conjunction with the laser system of FIG. 3 in accordance with the present disclosure.

FIG. 21 is another schematic view of the machining apparatus of FIG. 20 with various components omitted.

FIG. 22 is a schematic view of a top of a moving work platform of the machining apparatus of FIGS. 20 and 21.

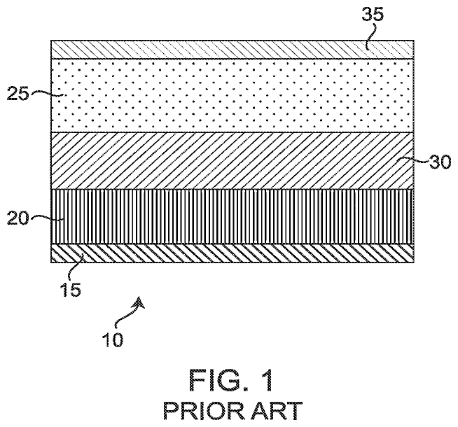

Corresponding reference numerals used throughout the drawings indicate corresponding components.

### Definitions

“A,” “an,” and “the” (i.e., singular forms) as used herein refer to plural referents unless the context clearly dictates otherwise. For example, in one instance, reference to “an electrode” includes both a single electrode and a plurality of similar electrodes.

“About” and “approximately” as used herein refers to plus or minus 10%, 5%, or 1% of the value stated. For example, in one instance, about 250 micrometers (μm) would include 225 μm to 275 μm. By way of further example, in one instance, about 1,000 μm would include 900 μm to 1,100 μm. Unless otherwise indicated, all numbers expressing quantities (e.g., measurements, and the like) and so forth used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques.

“Anode” as used herein in the context of a secondary battery refers to the negative electrode in the secondary battery.

“Anode material” or “Anodically active material” as used herein means material suitable for use as the negative electrode of a secondary battery.

“Cathode” as used herein in the context of a secondary battery refers to the positive electrode in the secondary battery.

“Cathode material” or “Cathodically active material” as used herein means material suitable for use as the positive electrode of a secondary battery.

“Conversion chemistry active material” or “Conversion chemistry material” refers to a material that undergoes a chemical reaction during the charging and discharging cycles of a secondary battery.

“Counter-electrode” as used herein may refer to the negative or positive electrode (anode or cathode), opposite of the Electrode, of a secondary battery unless the context clearly indicates otherwise.

“Counter-electrode structure” as used herein may refer to an electrochemical structure adapted for use in a secondary battery, opposite of an Electrode structure, that includes a counter-electrode current collector and a counter-electrode material. A Counter-electrode structure may be an anode structure (e.g., a negative electrode structure) including an anode current collector and anode material or a cathode structure (e.g., a positive electrode structure) including a cathode current collector and cathode material, opposite of the Electrode structure, unless the context clearly indicates otherwise.

“Counter-electrode current collector” as used herein may refer to the negative or positive (anode or cathode) current collector, opposite of the Electrode current connector, of a secondary battery unless the context clearly indicates otherwise.

“Counter-electrode material” as used herein may refer to anode material or cathode material, opposite of the Electrode material, unless the context clearly indicates otherwise.

“Cycle” as used herein in the context of cycling of a secondary battery between charged and discharged states refers to charging and/or discharging a battery to move the battery in a cycle from a first state that is either a charged or discharged state, to a second state that is the opposite of the first state (i.e., a charged state if the first state was discharged, or a discharged state if the first state was charged), and then moving the battery back to the first state to complete the cycle. For example, a single cycle of the secondary battery between charged and discharged states can include, as in a charge cycle, charging the battery from a discharged state to a charged state, and then discharging back to the discharged state, to complete the cycle. The single cycle can also include, as in a discharge cycle, discharging the battery from the charged state to the discharged state, and then charging back to a charged state, to complete the cycle.

“Electrochemically active material” as used herein means anodically active material or cathodically active material.

“Electrode” as used herein may refer to the negative or positive electrode (anode or cathode) of a secondary battery unless the context clearly indicates otherwise.

“Electrode structure” as used herein may refer to an electrochemical structure adapted for use in a secondary battery and that includes an electrode current collector and an electrode material. An Electrode structure may be an anode structure (e.g., a negative electrode structure) including an anode current collector and anode material or a cathode structure (e.g., a positive electrode structure) including a cathode current collector and cathode material unless the context clearly indicates otherwise.

“Electrode current collector” as used herein may refer to the negative or positive (anode or cathode) current collector of a secondary battery unless the context clearly indicates otherwise.

“Electrode material” as used herein may refer to anode material, cathode material, or separator material unless the context clearly indicates otherwise.

“Capacity” or “C” as used herein refers to an amount of electric charge that a battery (or a sub-portion of a battery comprising one or more pairs of electrode structures and counter-electrode structures that form a bilayer) can deliver at a pre-defined voltage unless the context clearly indicates otherwise.

“Electrolyte” as used herein refers to a non-metallic liquid, gel, or solid material in which current is carried by the movement of ions adapted for use in a battery unless the context clearly indicates otherwise.

“Charged state” as used herein in the context of the state of a secondary battery refers to a state where the secondary battery is charged to at least 75% of its rated capacity unless the context clearly indicates otherwise. For example, the battery may be charged to at least 80% of its rated capacity, at least 90% of its rated capacity, and even at least 95% of its rated capacity, such as 100% of its rated capacity.

“Discharge capacity” as used herein in connection with a negative electrode means the quantity of carrier ions available for extraction from the negative electrode and insertion into the positive electrode during a discharge operation of the battery between a predetermined set of cell end of charge and end of discharge voltage limits unless the context clearly indicates otherwise.

“Discharged state” as used herein in the context of the state of a secondary battery refers to a state where the secondary battery is discharged to less than 25% of its rated capacity unless the context clearly indicates otherwise. For example, the battery may be discharged to less than 20% of its rated capacity, such as less than 10% of its rated capacity, and even less than 5% of its rated capacity, such as 0% of its rated capacity.

“Reversible coulombic capacity” as used herein in connection with an electrode (i.e., a positive electrode, a negative electrode or an auxiliary electrode) means the total capacity of the electrode for carrier ions available for reversible exchange with a counter electrode.

“Longitudinal axis,” “transverse axis,” and “vertical axis,” as used herein refer to mutually perpendicular axes (i.e., each are orthogonal to one another). For example, the “longitudinal axis,” “transverse axis,” and the “vertical axis” as used herein are akin to an X axis, a Y axis, and a Z axis, respectively, of a Cartesian coordinate system used to define three-dimensional aspects or orientations. As such, the descriptions of elements of the disclosed subject matter herein are not limited to the particular axis or axes used to describe three-dimensional orientations of the elements. Alternatively stated, the axes may be interchangeable when referring to three-dimensional aspects of the disclosed subject matter.

“Composite material” or “Composite” as used herein refers to a material which comprises two or more constituent materials unless the context clearly indicates otherwise.

“Void fraction” or “Porosity” or “Void volume fraction” as used herein refers to a measurement of the voids (i.e., empty) spaces in a material, and is a fraction of the volume of voids over the total volume of the material, between 0 and 1, or as a percentage between 0% and 100%.

“Polymer” as used herein may refer to a substance or material consisting of repeating subunits of macromolecules unless the context clearly indicates otherwise.

“Microstructure” as used herein may refer to the structure of a surface of a material revealed by an optical microscope above about 25× magnification unless the context clearly indicates otherwise.

“Microporous” as used herein may refer to a material containing pores with diameters less than about 2 nanometers unless the context clearly indicates otherwise.

“Macroporous” as used herein may refer to a material containing pores with diameters greater than about 50 nanometers unless the context clearly indicates otherwise.

“Nanoscale” or “Nanoscopic scale” as used herein may refer to structures with a length scale in the range of about 1 nanometer to about 100 nanometers.

“Separator,” “Separator layer,” or “Separator structure” as used herein may refer to electrically insulating but ionically permeable separator material that is adapted to electrically isolate an electrode structure from an adjacent counter-electrode structure.

“Unit cell” as used herein may refer to a subassembly of a secondary battery that includes an electrode structure, a counter-electrode structure, and a separator between the electrode structure and the counter-electrode structure. A pair of adjacent unit cells of a secondary battery may be arranged with an electrode structure of a first unit cell of the pair adjacent to a counter-electrode structure of a second unit cell of the pair and may share a common separator between the electrode structure of the first unit cell and the counter-electrode structure of the second unit cell.

“Weakened region” refers to a portion of the web that has undergone a processing operation such as scoring, cutting, perforation or the like such that the local rupture strength of the weakened region is lower than the rupture strength of a non-weakened region.

### DETAILED DESCRIPTION

Embodiments of the present disclosure relate to apparatus, systems and methods for the production of electrode components for batteries, such as three-dimensional secondary batteries that improve the speed of manufacture of the electrode components, while retaining or improving battery capacity and battery longevity, and reducing the occurrences of defects during the manufacturing process.

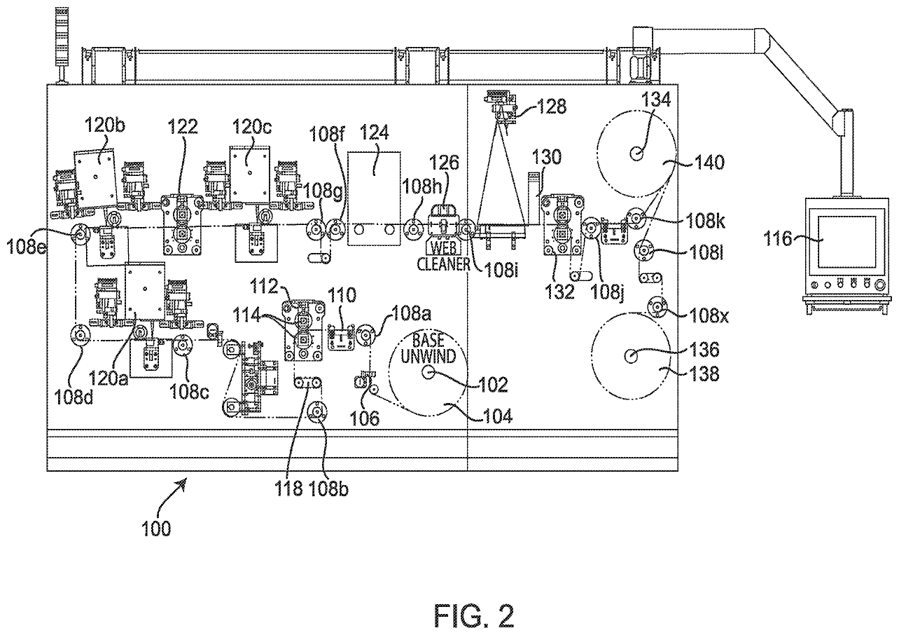

An example system for the production of electrode components, including electrodes and separators, for use in batteries will be described with reference to FIG. 2. The electrode production (or manufacturing) system, indicated generally at 100, includes a number of discrete stations, systems, components, or apparatuses that function to enable the efficient production of precision electrodes for use in batteries. The production system 100 is described first generally, with respect to FIG. 2, and subsequently additional detail of each component is then further described after the broader production system 100 is introduced.

The production system 100 may include a control system that facilitates controlling the components of the production system. The control system may be a central controller that is in communication with each component, or may be decentralized and in the form of discrete controllers located at each component. In the example embodiment, the control system is provided at a user interface 116 of the production system 100. The user interface 116 may include a memory configured to store instructions and a processor configured to execute the stored instructions to cause the production system 100 to function as described herein. The user interface 116 may further include a display device, such as an LCD or LED display and a set of controls, or virtual controls, that allow a user to control and adjust parameters of the production system 100, as well as view metrics such as web conveyance speed, tension, number of defects, and any other parameters that allow production system 100 to function as described herein.

In the illustrated embodiment, the production system 100 includes a base unwind roller 102 for holding and unwinding a web of base material 104. The web of base material 104 may be a web of electrode material. Electrode material includes, for example, anode material 502, cathode material 504, separator material, or the like suitable for the production of an electrode assembly for a secondary battery. The web of base material 104 is a thin sheet of material that has been wound into the form of a roll, having a center through hole sized for placement on the base unwind roller 102. In some embodiments, the web of base material 104 is a multi-layer material including, for example, an electrode current collector layer (i.e., an anode current collector layer 506 or a cathode current collector layer 510), and an electrochemically active material layer (i.e., an anodically active material layer 508 or a cathodically active material layer 512) on at least one major surface thereof, and in other embodiments the web of base material 104 may be a single layer (e.g., a web of separator material).

The base unwind roller 102 may be formed from metal, metal alloy, composite, plastic or any other material that allows the production system 100 to function as described herein. In one embodiment, the base unwind roller 102 is made of stainless steel and has a diameter of 3 inches (76.2 mm).

As seen in the embodiment of FIG. 2, the web of base material 104 is passed across an edge guide 106, to facilitate unwinding of the web of base material 104. In one embodiment, the edge guide 106 uses a through-beam type optical sensor to the position of one edge of the web of base material 104 relative to a fixed reference point. Feedback is sent from the edge guide 106 to a “web steering” roller, generally the base unwind roller 102, which will move in a direction perpendicular to the direction of travel of the web of base material 104. In this embodiment, the web of base material 104 then passes around an idler 108a and into a splicing station 110.

The idler 108a (also may be referred to as an idle roller) facilitates maintaining proper positioning and tension of the web of base material 104, as well as to change the direction of the web of base material 104. The idler 108a receives the web of base material 104 in an input direction, and is partially wrapped around the idler 108a such that the web of base material 104 leaves the idler 108a in an output direction that is different from the input direction. In the embodiment shown in FIG. 2, the input direction at which the web of base material 104 is received by the idler 108a is a vertical direction, the output direction is substantially ninety degrees from the input direction. The input and output directions may vary in other embodiments depending on the desired change in the direction of the web of base material 104.

In some embodiments, the production system 100 may use multiple idlers 108a-108x to change the direction of the web of base material 104 one or more times as it is conveyed through the production system 100. The idlers 108a-108x may be formed from metal, metal alloy, composite, plastic, rubber or any other material that allows the production system 100 to function as described herein. In one embodiment, the idlers 108a-108x are made of stainless steel and have dimensions of 1 inch (25.4 mm) diameter×18 inches (457.2 mm) length.

The splicing station 110 is configured to facilitate splicing (e.g., connecting) two separate webs together. In one suitable embodiment, as a first web of base material 104 is unwound, such that a trailing edge (not shown) of the web of base material 104 is stopped within the splicing station 110, a leading edge (not shown) of a second web of base material 104 is unwound into the splicing station 110 such that the trailing edge of the first web of base material 104 and the leading edge of the second web of base material 104 are adjacent one another. The user may then apply an adhesive, such as an adhesive tape, to join the leading edge of the second web of base material 104 to the trailing edge of the first web of base material 104 to form a seam between the two webs and create a continuous web of base material 104. Such process may be repeated for numerous webs of base material 104, as dictated by a user. Thus, the splicing station 110 allows for the possibility of having multiple webs of base material being spliced together to form one continuous web. It should be appreciated that in other embodiments, a user may splice webs of the same, or different, materials together if desired.

In one suitable embodiment, upon exiting the splicing station 110, the web of base material 104 is then conveyed in a down-web direction (indicated as WD throughout the Figures) such that it may enter a nip roller 112. The nip roller 112 is configured to facilitate controlling the speed at which the web of base material 104 is conveyed through the production system 100.

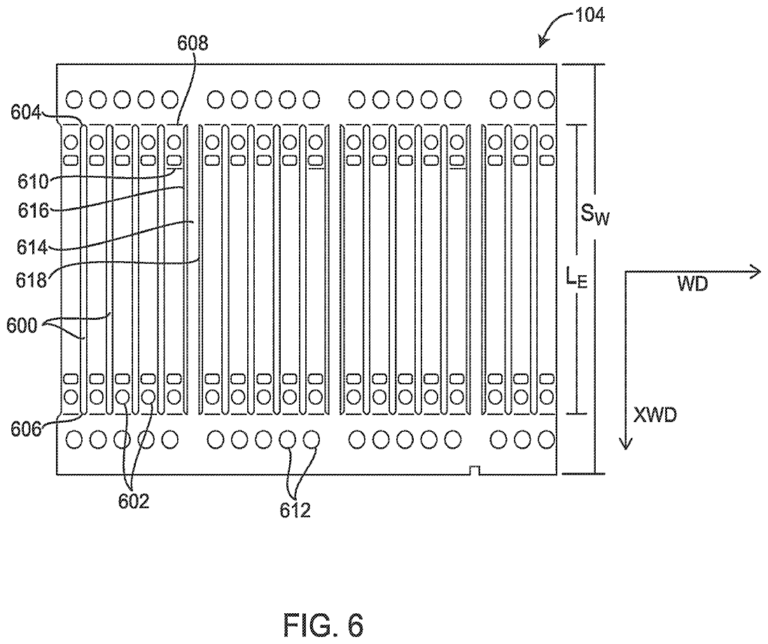

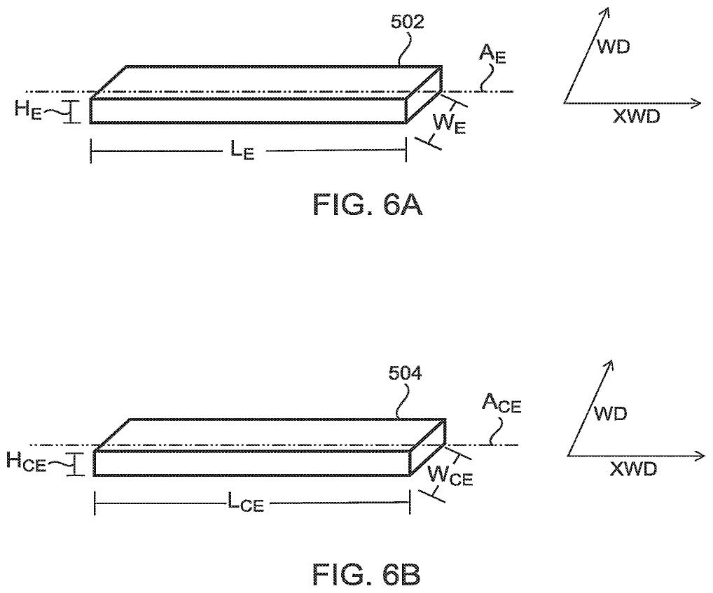

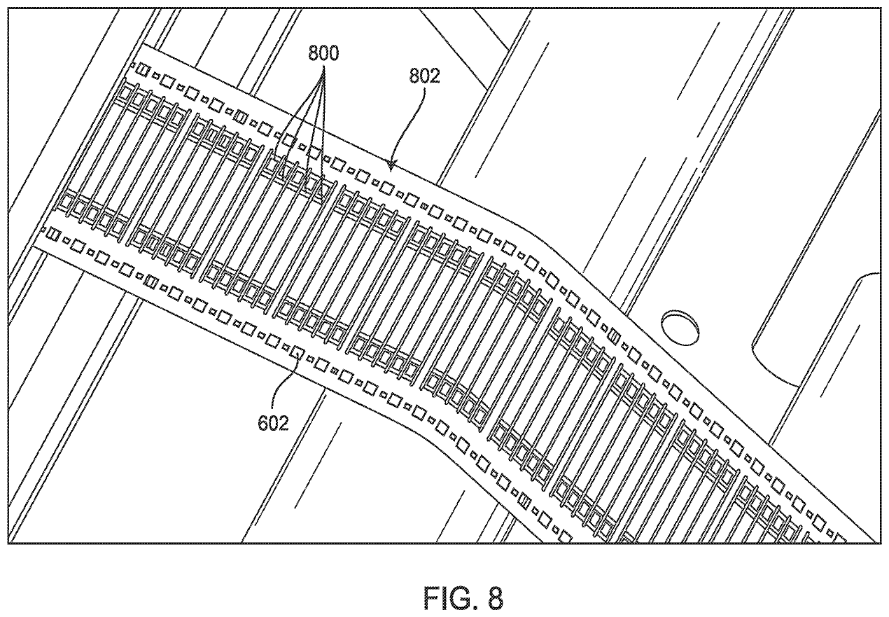

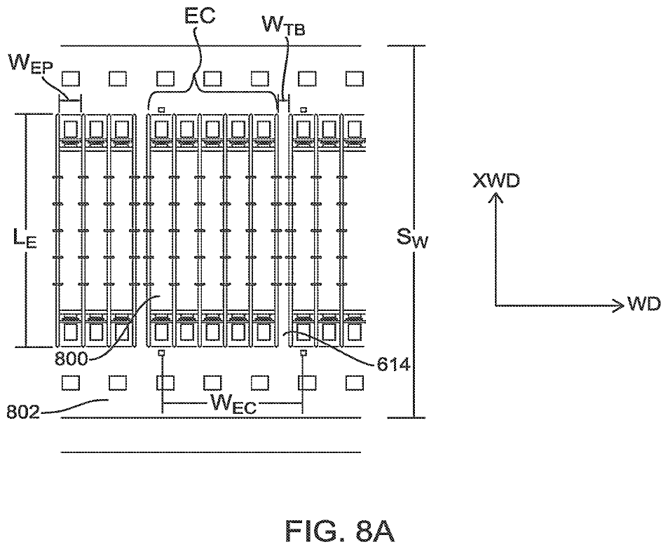

In one embodiment, the nip roller 112 includes at least two adjacent rollers 114 having a space therebetween defining a nip. The nip is sized such that the web of base material 104 is pressed against each of the two adjacent rollers 114, with enough pressure to allow friction of the rollers to move the web of base material 104, but a low enough pressure to avoid any significant deformation or damage to the web of base material 104. In some suitable embodiments, the pressure exerted against the web of base material 104 by the at least two adjacent rollers 114 is set between 0 to 210 pounds of force across the cross-web span of the web S_{W} (i.e., the edge to edge distance of the web in the cross-web direction XWD) (FIGS. 6, 8A) of base material 104 in the cross-web direction XWD, such as 0 lbs., 5 lbs., 10 lbs., 15 lbs., 20 lbs., 25 lbs., 30 lbs., 35 lbs., 40 lbs., 45 lbs., 50 lbs., 55 lbs., 60 lbs., 65 lbs., 70 lbs., 75 lbs., 80 lbs., 85 lbs., 90 lbs., 95 lbs., 100 lbs., 110 lbs., 120 lbs., 130 lbs., 140 lbs., 150 lbs., 160 lbs., 170 lbs., 180 lbs., 190 lbs., 200 lbs., or 210 lbs. of force.

In one suitable embodiment, at least one of the adjacent rollers 114 is a compliant roller which may be a high friction roller driven by an electric motor, and another of the adjacent rollers 114 is a low friction passive roller. The compliant roller may have at least an exterior surface made from rubber or polymer capable of providing sufficient grip on the web of base material 104 to provide a pushing or pulling force on the web of base material 104 to convey it through the production system 100. In one embodiment, at least one of the adjacent rollers 114 is a steel roller having a diameter of about 3.8 inches, such as 3.863 inches (98.12 mm). In another embodiment, at least one of the adjacent rollers 114 is a rubber roller having a diameter of about 2.5 inches, such as 2.54 inches (64.51 mm). In yet another embodiment, one or more of the adjacent rollers 114 include a rubber ring placed thereon which may be adjusted for placement at any location along the width of the roller, each ring having an outer diameter of about 3.90 inches (99.06 mm). The diameters of the rollers may be less than or greater than such amounts so long as the rollers function as described herein. In one embodiment, rubber rings are placed on the rollers to contact the web of base material 104 at a continuous outer edge thereof to drive the web of base material 104 in the down-web direction WD. Accordingly, the speed of the web of base material 104 is controlled by controlling the rate of rotation of the high friction roller (e.g., via user interface 116). In other embodiments, each of the adjacent rollers 114 may be made from any high friction or low friction material, that allows the production system 100 to function as described herein.

One or a plurality of the adjacent rollers 114 may be connected to a motor (not shown) for controlling the speed of the web of base material 104 passing through the nip. The production system 100 may include one or more additional nip rollers 122, 132 to facilitate control of the speed of the web of base material 104 conveyed through the production system 100, which may be controlled via user interface 116. When multiple nip rollers 112, 122, and 132 are used, each of the nip rollers 112, 122, and 132 may be set via user interface 116 to the same speed such that the web of base material 104 is conveyed smoothly through production system 100.

In one embodiment, one or more of the rollers of the conveyor system may not be perfectly round, such that the roller has an eccentricity. In such case, especially if the eccentric roller is a nip roller 112, 123, 132, the web of base material 104 may be conveyed in a manner such that a position of the web of base material 104 advances in a manner differently depending upon which portion of the eccentric roller is in contact with the web. For example, if the eccentric roller has a portion of the radius that exceeds the expected radius of the roller, the web may advance further in the down-web direction WD than expected, when the larger radius portion of the roller is pushing/pulling the web. Likewise, if the eccentric roller has a reduced radius portion, the web may advance a reduced distance in the down-web direction WD than expected. Accordingly, in one embodiment, the eccentric roller(s) may be mapped to determine the radius versus radial position. In one embodiment, the mapping of the rollers may be stored in the memory of the user interface 116.

The production system 100 may also include a dancer 118. In the embodiment of FIG. 2, the dancer 118 includes a pair of rollers spaced apart from one another, but connected about a central axis between the pair of rollers of the dancer 118. The pair of rollers of the dancer 118 may rotate about the central axis, thereby passively adjusting the tension on the web of base material 104.

If the tension on the web of base material 104 exceeds a predetermined threshold, the pair of rollers of the dancer 118 may rotate about the central axis to reduce the tension on the web. The dancer 118 may use the mass of the dancer 118 alone (e.g., the mass of one or more of the pair of rollers), a spring, torsion rod or other biasing/tensioning device which may be user adjustable or controllable via user interface 116, to ensure a proper tension is consistently maintained on the web of base material 104. In one embodiment, the mass of the dancer 118 and inertia of the dancer 118 are reduced or minimized to allow for web tension at or below 10000 gram force, for example by using hollow rollers made of aluminum. The web tension may suitably be at or below 1000 gram force, or at or below 500 gram force. In other embodiments, the rollers of the dancer 118 are made of other lightweight materials such as carbon fiber, aluminum alloys, magnesium, other lightweight metals and metal alloys, fiberglass or any other suitable material that allows for a mass low enough to provide a web tension at or below 10000 gram force, such as at or below 1000 gram force, or at or below 500 gram force. In yet another embodiment, the rollers of the dancer 118 are counterbalanced to allow a tension in the web of base material 104 of 250 gram force or less.

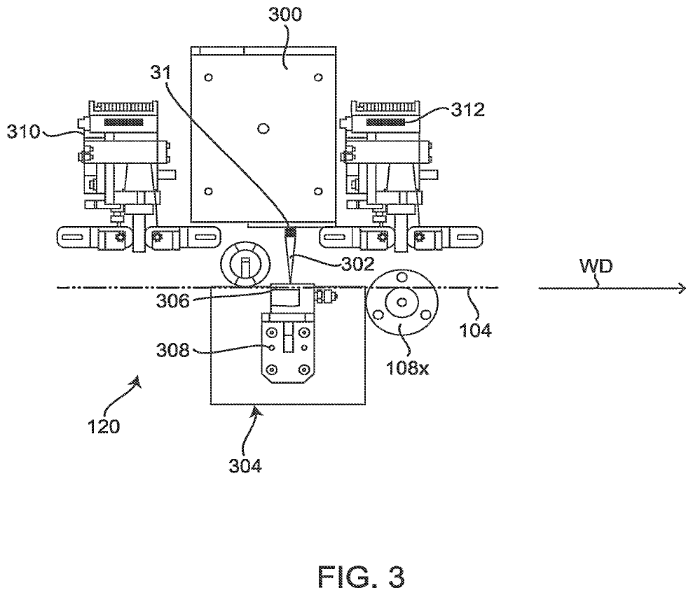

The production system 100 includes one or more laser systems 120a, 120b, and 120c. The embodiment shown in FIG. 2 includes three laser systems 120a-c, but it should be appreciated that any number of laser systems 120 may be used to allow the production system 100 to function as described herein. Further description of the laser systems 120a-c is made with reference to FIG. 3. One or more of the laser systems 120a-c may include a laser device 300 that emits a laser beam 302.

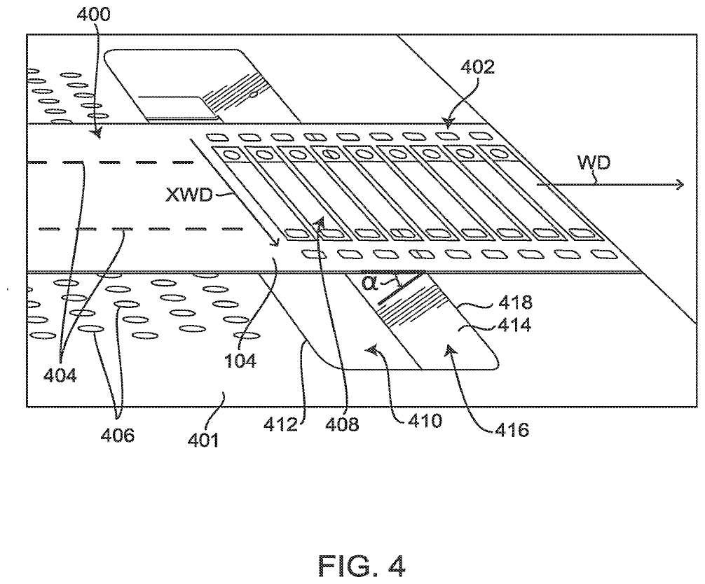

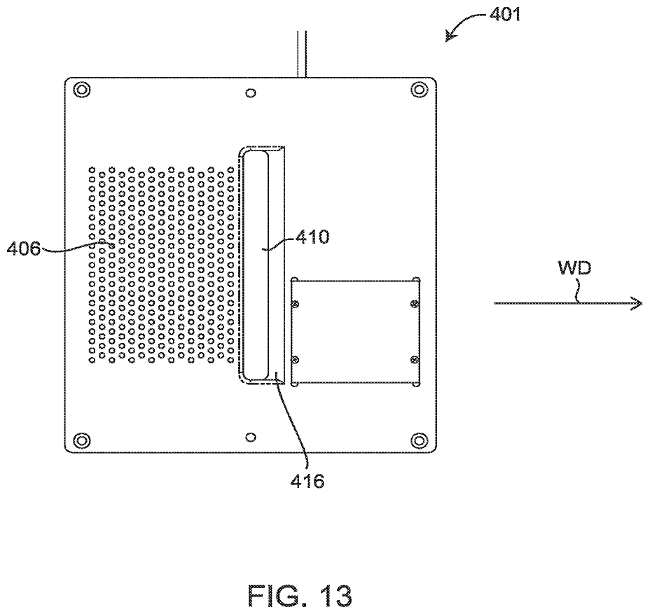

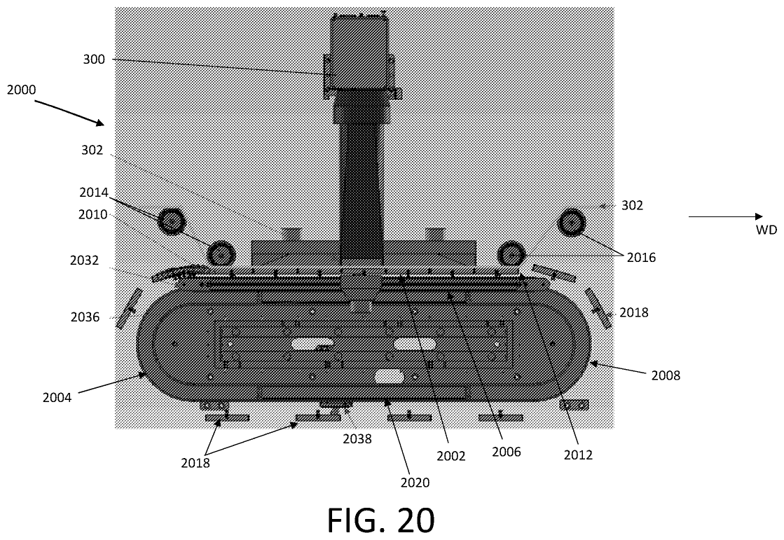

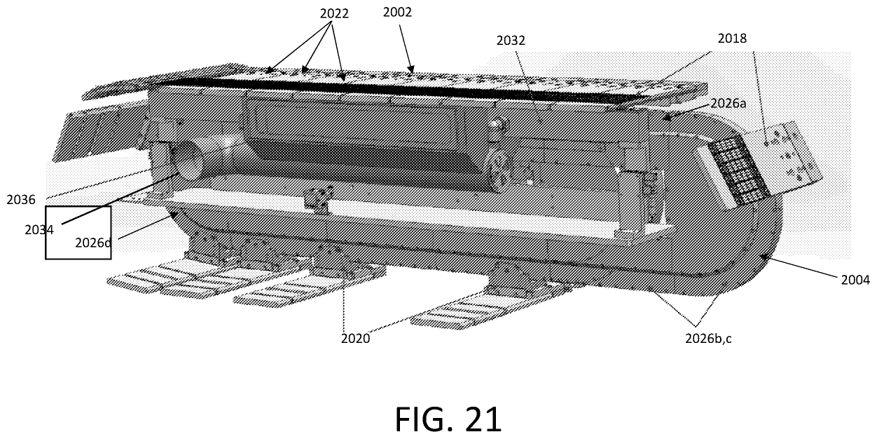

The laser device 300 of the laser systems 120a-c may emit the laser beam 302 toward a cutting assembly 304. The cutting assembly 304 may include a work platform 306 and a vacuum 308. In some embodiments, the work platform 306 is a stationary chuck 401. Details of the chuck 401 are best shown in FIGS. 4 and 13, further described below. In example embodiments, the work platform 306 is a work platform 2002 that moves continuously along a track 2004 to enable inline cleaning and debris removal from the work platform without ceasing operation of the laser device 300. Details of the moving work platform 2002 and track 2004 are described below with reference to FIGS. 20-22, which depict an example apparatus 2000 that facilitates machining the web of base material 104 moving in the down-web direction WD in accordance with embodiments of the present disclosure. Although a track is described, in some embodiments a cylinder with the same or similar work surface geometry may be used.

In one suitable embodiment, adjacent one or more of the laser systems 120, are one or more inspection devices 310, 312, which may be visual inspection devices such as a camera or any other suitable inspection system which allows the production system 100 to function as further described herein. In some embodiments, the one or more inspection devices 310, 312 may be laser-based inspection device using one or more beams and/or retroreflective sensors.

The example production system 100 illustrated in FIG. 2 includes one or more cleaning stations such as brushing station 124 and air knife 126. Each cleaning station is configured to remove or otherwise facilitate removal of debris (not shown) from the web of base material 104, as described further herein. In example embodiments, one or more inline cleaning stations 2038 (e.g., an inline brushing station 124 and/or an inline air knife 126) are located adjacent the moving platform 2002 to enable inline cleaning and debris removal from the work platform without ceasing operation of the laser device 300 (FIG. 3). Details of the inline cleaning station 2038 are described below with reference to FIGS. 20-22.

The production system 100 of FIG. 2 includes an inspection station 128 to identify defects and an associated defect marking system 130 to mark the web of base material 104 to identify locations of identified defects, as described further herein.

In one suitable embodiment, the web of base material 104 is rewound via a rewind roller 134 together with a web of interleaf material 138, which is unwound via interleaf roller 136 to create a roll of electrodes 140 with layers of the electrodes separated by a web of interleaf material 138. In some embodiments, the web of base material 104 can be rewound via the rewind roller 134 without the web of interleaf material 138.

The series of nip rollers 112, 122, and 132, idlers 108a-x, and dancers 118 may be together referred to as a conveying system for conveying the web of base material 104 through the production system 100. As used herein, a conveying system or conveying of the web of base material 104 refers to intended movement of the web of base material 104 through the production system 100 in the down-web direction WD.

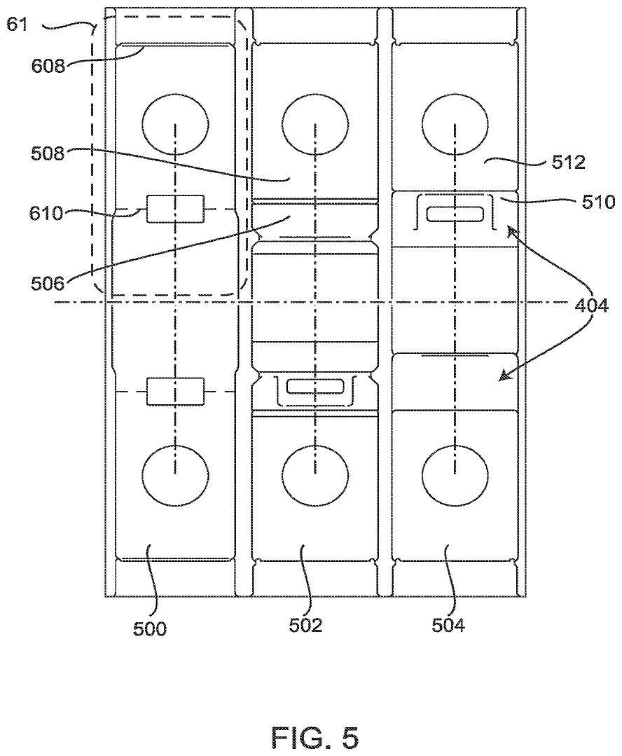

With reference to FIG. 5, the web of base material 104 may be any material suitable for the production of electrode components for use in batteries as described herein. For example, web of base material 104 may be an electrically insulating separator material 500, an anode material 502 or a cathode material 504. In one suitable embodiment, the web of base material 104 is an electrically insulating and ionically permeable polymeric woven material suitable for use as a separator in a secondary battery. In some embodiments, the web of base material 104 may be a solid electrolyte.

In another suitable embodiment, the web of base material 104 is a web of anode material 502, which may include an anode current collector layer 506 and an anodically active material layer 508. In one embodiment, the anode current collector layer 506 comprises a conductive metal such as copper, copper alloys or any other material suitable as an anode current collector layer. The anodically active material layer 508 may be formed as a first layer on a first surface of the anode current collector layer 506 and a second layer on a second opposing surface of the anode current collector layer 506. In another embodiment, the anode current collector layer 506 and anodically active material layer 508 may be intermixed. The first surface and the second opposing surface may be referred to as major surfaces, or front and back surfaces, of the web of base material 104. A major surface, as used herein, refers to the surfaces defined by the plane formed by the length of the web of base material 104 in the down-web direction (indicated as WD throughout the Figures) and the span of the web of base material 104 in a cross web direction (indicated as XWD throughout the Figures).

When the web of base material 104 is a web of anode material 502, the anodically active material layer(s) 508 thereof may (each) have a thickness of at least about 10 μm. For example, in one embodiment, the anodically active material layer(s) 508 may (each) have a thickness of at least about 40 μm. By way of further example, in one such embodiment the anodically active material layer(s) 508 may (each) have a thickness of at least about 80 μm. By way of further example, in one such embodiment the anodically active material layers 508 may (each) have a thickness of at least about 120 μm. Typically, however, the anodically active material layer(s) 508 may (each) have a thickness of less than about 60 μm or even less than about 30 μm.

Example anodically active materials for use as the anodically active material layer(s) 508 include carbon materials such as graphite, soft or hard carbons, or graphene (e.g., single-walled or multi-walled carbon nanotubes), or any of a range of metals, semi-metals, alloys, oxides, nitrides and compounds capable of intercalating lithium or forming an alloy with lithium. Specific examples of the metals or semi-metals capable of constituting the anode material 502 include graphite, tin, lead, magnesium, aluminum, boron, gallium, silicon, Si/C composites, Si/graphite blends, silicon oxide (SiOx), porous Si, intermetallic Si alloys, indium, zirconium, germanium, bismuth, cadmium, antimony, silver, zinc, arsenic, hafnium, yttrium, lithium, sodium, graphite, carbon, lithium titanate, palladium, and mixtures thereof. In one embodiment, the anodically active material layer 508 includes aluminum, tin, or silicon, or an oxide thereof, a nitride thereof, a fluoride thereof, or other alloy thereof. In another embodiment, the anodically active material layer 508 includes silicon or an alloy or oxide thereof.

In one embodiment, the anodically active material layer 508 is microstructured to provide a significant void volume fraction to accommodate volume expansion and contraction as lithium ions (or other carrier ions) are incorporated into or leave the anodically active material layer 508 during charging and discharging processes. In general, the void volume fraction of (each of) the anodically active material layer(s) 508 is at least 0.1. Typically, however, the void volume fraction of (each of) the anodically active material layer(s) 508 is not greater than 0.8. For example, in one embodiment, the void volume fraction of (each of) the anodically active material layer(s) 508 is about 0.15 to about 0.75. By way of the further example, in one embodiment, the void volume fraction of (each of) the anodically active material layer(s) 508 is about 0.2 to about 0.7. By way of the further example, in one embodiment, the void volume fraction of (each of) the anodically active material layer(s) 508 is about 0.25 to about 0.6.

Depending upon the composition of the microstructured anodically active material layer 508 and the method of its formation, the microstructured anodically active material layer 508 may comprise macroporous, microporous, or mesoporous material layers or a combination thereof, such as a combination of microporous and mesoporous, or a combination of mesoporous and macroporous. Microporous material is typically characterized by a pore dimension of less than 10 nm, a wall dimension of less than 10 nm, a pore depth of 1-50 micrometers, and a pore morphology that is generally characterized by a “spongy” and irregular appearance, walls that are not smooth, and branched pores. Mesoporous material is typically characterized by a pore dimension of 10-50 nm, a wall dimension of 10-50 nm, a pore depth of 1-100 micrometers, and a pore morphology that is generally characterized by branched pores that are somewhat well defined or dendritic pores. Macroporous material is typically characterized by a pore dimension of greater than 50 nm, a wall dimension of greater than 50 nm, a pore depth of 1-500 micrometers, and a pore morphology that may be varied, straight, branched, or dendritic, and smooth or rough-walled.

The void volume may include open or closed voids, or a combination thereof. In one embodiment, the void volume comprises open voids, that is, the anodically active material layer 508 contains voids having openings at the lateral surface of the anodically active material layer 508 through which lithium ions (or other carrier ions) can enter or leave the anodically active material layer 508; for example, lithium ions may enter the anodically active material layer 508 through the void openings after leaving the cathodically active material layer 512. In another embodiment, the void volume comprises closed voids, that is, the anodically active material layer 508 contains voids that are enclosed within the anodically active material layer 508. In general, open voids can provide greater interfacial surface area for the carrier ions whereas closed voids tend to be less susceptible to solid electrolyte interface while each provides room for expansion of the anodically active material layer 508 upon the entry of carrier ions. In certain embodiments, therefore, it is preferred that the anodically active material layer 508 comprise a combination of open and closed voids.

In one embodiment, the anodically active material layer 508 comprises porous aluminum, tin or silicon or an alloy, an oxide, or a nitride thereof. Porous silicon layers may be formed, for example, by anodization, by etching (e.g., by depositing precious metals such as gold, platinum, silver or gold/palladium on the surface of single crystal silicon and etching the surface with a mixture of hydrofluoric acid and hydrogen peroxide), or by other methods known in the art such as patterned chemical etching.

The porous anodically active material layer 508 may have a porosity fraction of at least about 0.1, but less than 0.8 and have a thickness of about 1 to about 100 micrometers. For example, in one embodiment, the anodically active material layer 508 comprises porous silicon, has a thickness of about 5 to about 100 micrometers, and has a porosity fraction of about 0.15 to about 0.75. By way of further example, in one embodiment, the anodically active material layer 508 comprises porous silicon, has a thickness of about 10 to about 80 micrometers, and has a porosity fraction of about 0.15 to about 0.7. By way of further example, in one such embodiment, the anodically active material layer 508 comprises porous silicon, has a thickness of about 20 to about 50 micrometers, and has a porosity fraction of about 0.25 to about 0.6. By way of further example, in one embodiment, the anodically active material layer 508 comprises a porous silicon alloy (such as nickel silicide), has a thickness of about 5 to about 100 micrometers, and has a porosity fraction of about 0.15 to about 0.75.

In another embodiment, the anodically active material layer 508 comprises fibers of aluminum, tin or silicon, or an alloy thereof. Individual fibers may have a diameter (thickness dimension) of about 5 nm to about 10,000 nm and a length generally corresponding to the thickness of the anodically active material layer 508. Fibers (nanowires) of silicon may be formed, for example, by chemical vapor deposition or other techniques known in the art such as vapor liquid solid (VLS) growth and solid liquid solid (SLS) growth. Additionally, the anodically active material layer 508 will generally have a porosity fraction of at least about 0.1, but less than 0.8 and have a thickness of about 1 to about 200 micrometers. For example, in one embodiment, the anodically active material layer 508 comprises silicon nanowires, has a thickness of about 5 to about 100 micrometers, and has a porosity fraction of about 0.15 to about 0.75. By way of further example, in one embodiment, the anodically active material layer 508 comprises silicon nanowires, has a thickness of about 10 to about 80 micrometers, and has a porosity fraction of about 0.15 to about 0.7. By way of further example, in one such embodiment, the anodically active material layer 508 comprises silicon nanowires, has a thickness of about 20 to about 50 micrometers, and has a porosity fraction of about 0.25 to about 0.6. By way of further example, in one embodiment, the anodically active material layer 508 comprises nanowires of a silicon alloy (such as nickel silicide), has a thickness of about 5 to about 100 micrometers, and has a porosity fraction of about 0.15 to about 0.75.

The anode current collector layer 506 may have an electrical conductivity of at least about 10³ Siemens/cm. For example, in one such embodiment, the anode current collector layer 506 may have a conductivity of at least about 10⁴ Siemens/cm. By way of further example, in one such embodiment, the anode current collector layer 506 may have a conductivity of at least about 10⁵ Siemens/cm. Example electrically conductive materials suitable for use as anode current collector layers 506 include metals, such as, copper, nickel, cobalt, titanium, and tungsten, and alloys thereof.

Referring again to FIG. 5, in another suitable embodiment, the web of base material 104 is a web of cathode material 504, which may include a cathode current collector layer 510 and a cathodically active material layer 512. The cathode current collector layer 510 of the cathode material 504 may comprise aluminum, an aluminum alloy, titanium or any other material suitable for use as a cathode current collector layer 510. The cathodically active material layer 512 may be formed as a first layer on a first surface of the cathode current collector layer 510 and a second layer on a second opposing surface of the cathode current collector layer 510. The cathodically active material layer 512 may be coated onto one or both sides of cathode current collector layer 510. Similarly, the cathodically active material layer 512 may be coated onto one or both major surfaces of cathode current collector layer 510. In another embodiment, the cathode current collector layer 510 may be intermixed with cathodically active material layer 512.

When the web of base material 104 is a web of cathode material 504, the cathodically active material layer(s) 512 thereof may (each) have a thickness of at least about 20 μm. For example, in one embodiment, the cathodically active material layer(s) 512 may (each) have a thickness of at least about 40 μm. By way of further example, in one such embodiment the cathodically active material layer(s) 512 may (each) have a thickness of at least about 60 μm. By way of further example, in one such embodiment the cathodically active material layer(s) 512 may (each) have a thickness of at least about 100 μm. Typically, however, the cathodically active material layer(s) 512 (each) have a thickness of less than about 90 μm or even less than about 70 μm.

Exemplary cathodically active materials include any of a wide range of cathodically active materials. For example, for a lithium-ion battery, the cathodically active material layer 512 may comprise a cathodically active material selected from transition metal oxides, transition metal sulfides, transition metal nitrides, lithium-transition metal oxides, lithium-transition metal sulfides, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathodically active materials include LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co_{z})O₂, and combinations thereof. In some embodiments, the cathodically active material is a sodium-based material.

The cathode current conductor layer 510 may have an electrical conductivity of at least about 10³ Siemens/cm. For example, in one such embodiment, the cathode current conductor layer 510 may have a conductivity of at least about 10⁴ Siemens/cm. By way of further example, in one such embodiment, the cathode current conductor layer 510 may have a conductivity of at least about 10⁵ Siemens/cm. Exemplary cathode current conductor layers 510 include metals, such as aluminum, nickel, cobalt, titanium, and tungsten, and alloys thereof.

Referring again to FIG. 5, in another suitable embodiment, the web of base material 104 is a web of electrically insulating but ionically permeable separator material. Electrically insulating separator materials 500 are adapted to electrically isolate each member of the anode population from each member of the cathode population of a secondary battery. Electrically insulating separator material 500 may include a microporous separator material that can be permeated with a non-aqueous electrolyte. For example, in one embodiment, the microporous separator material includes pores having a diameter of at least 50 Å, or in the range of about 2,500 Å, and a porosity in the range of about 25% to about 75%, or in the range of about 35-55%

When the web of base material 104 is a web of electrically insulating separator material 500, the electrically insulating separator material 500 will have a thickness of at least about 4 μm. For example, in one embodiment, the electrically insulating separator material 500 will have a thickness of at least about 8 μm. By way of further example, in one such embodiment the electrically insulating separator material 500 will have a thickness of at least about 12 μm. By way of further example, in one such embodiment the electrically insulating separator material 500 will have a thickness of at least about 15 μm. Typically, however, the electrically insulating separator material 500 will have a thickness of less than about 12 μm or even less than about 10 μm.

In one embodiment, the microporous separator material comprises a particulate material and a binder, and has a porosity (void fraction) of at least about 20 vol. % The pores of the microporous separator material will have a diameter of at least 50 Å and will typically fall within the range of about 250 to 2,500 Å. The microporous separator material will typically have a porosity of less than about 75 vol %. In one embodiment, the microporous separator material has a porosity (void fraction) of at least about 25 vol %. In one embodiment, the microporous separator material will have a porosity of about 35-55 vol %.

The binder for the microporous separator material may be selected from a wide range of inorganic or polymeric materials. For example, in one embodiment, the binder is an organic material selected from the group consisting of silicates, phosphates, aluminates, aluminosilicates, and hydroxides such as magnesium hydroxide, calcium hydroxide, etc. For example, in one embodiment, the binder is a fluoropolymer derived from monomers containing vinylidene fluoride, hexafluoropropylene, tetrafluoropropene, and the like. In another embodiment, the binder is a polyolefin such as polyethylene, polypropylene, or polybutene, having any of a range of varying molecular weights and densities. In another embodiment, the binder is selected from the group consisting of ethylene-diene-propene terpolymer, polystyrene, polymethyl methacrylate, polyethylene glycol, polyvinyl acetate, polyvinyl butyral, polyacetal, and polyethyleneglycol diacrylate. In another embodiment, the binder is selected from the group consisting of methyl cellulose, carboxymethyl cellulose, styrene rubber, butadiene rubber, styrene-butadiene rubber, isoprene rubber, polyacrylamide, polyvinyl ether, polyacrylic acid, polymethacrylic acid, and polyethylene oxide. In another embodiment, the binder is selected from the group consisting of acrylates, styrenes, epoxies, and silicones. In another embodiment, the binder is a copolymer or blend of two or more of the aforementioned polymers.

Particulate material included in the microporous separator material may also be selected from a wide range of materials. Such particulate materials may have a relatively low electronic and ionic conductivity at operating temperatures and do not corrode under the operating voltages of the battery electrode or current collector contacting the microporous separator material. For example, in one embodiment, the particulate material has a conductivity for carrier ions (e.g., lithium) of less than 1×10⁻⁴ S/cm. By way of further example, in one embodiment, the particulate material has a conductivity for carrier ions of less than 1×10⁻⁵ S/cm. By way of further example, in one embodiment, the particulate material has a conductivity for carrier ions of less than 1×10⁻⁶ S/cm.

Example particulate materials include particulate polyethylene, polypropylene, a TiO₂-polymer composite, silica aerogel, fumed silica, silica gel, silica hydrogel, silica xerogel, silica sol, colloidal silica, alumina, titania, magnesia, kaolin, talc, diatomaceous earth, calcium silicate, aluminum silicate, calcium carbonate, magnesium carbonate, or a combination thereof. For example, in one embodiment, the particulate material comprises a particulate oxide or nitride such as TiO₂, SiO₂, Al₂O₃, GeO₂, B₂O₃, Bi₂O₃, BaO, ZnO, ZrO₂, BN, Si₃N₄, Ge₃N₄. See, for example, P. Arora and J. Zhang, “Battery Separators” Chemical Reviews 2004, 104, 4419-4462. In one embodiment, the particulate material will have an average particle size of about 20 nm to 2 micrometers, more typically 200 nm to 1.5 micrometers. In one embodiment, the particulate material will have an average particle size of about 500 nm to 1 micrometer.

In an alternative embodiment, the particulate material included in the microporous separator material may be bound by techniques such as, for example, sintering, binding, and/or curing, while maintaining the void fraction desired for electrolyte ingress to provide the ionic conductivity for the functioning of the battery.

In an assembled energy storage device, the microporous separator material is permeated with a non-aqueous electrolyte suitable for use as a secondary battery electrolyte. The non-aqueous electrolyte may include a lithium salt and/or mixture of salts dissolved in an organic solvent and/or solvent mixture. Example lithium salts include inorganic lithium salts such as LiClO₄, LiBF₄, LiPF₆, LiAsF₆, LiCl, and LiBr; and organic lithium salts such as LiB(C₆H₅)₄, LiN(SO₂CF₃)₂, LiN(SO₂CF₃)₃, LiNSO₂CF₃, LiNSO₂CF₅, LiNSO₂C₄F₉, LiNSO₂C₅F₁₁, LiNSO₂C₆F₁₃, and LiNSO₂C₇F₁₅. Example organic solvents to dissolve the lithium salt include cyclic esters, chain esters, cyclic ethers, and chain ethers. Specific examples of the cyclic esters include propylene carbonate, butylene carbonate, γ-butyrolactone, vinylene carbonate, 2-methyl-γ-butyrolactone, acetyl-γ-butyrolactone, and γ-valerolactone. Specific examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionates, dialkyl malonates, and alkyl acetates. Specific examples of the cyclic ethers include tetrahydrofuran, alkyltetrahydrofurans, dialkyltetrahydrofurans, alkoxytetrahydrofurans, dialkoxytetrahydrofurans, 1,3-dioxolane, alkyl-1,3-dioxolanes, and 1,4-dioxolane. Specific examples of the chain ethers include 1,2-dimethoxyethane, 1,2-diethoxythane, diethyl ether, ethylene glycol dialkyl ethers, diethylene glycol dialkyl ethers, triethylene glycol dialkyl ethers, and tetraethylene glycol dialkyl ethers.

In yet other embodiments, the web of base material 104 may be any material suitable for the production of electrode components for use in solid state secondary batteries, such as those described in U.S. Pat. No. 9,553,332, issued Jan. 24, 2017, which is hereby incorporated herein by reference in its entirety. For example, in some embodiments, the web of base material 104 may comprise an electrode current collector material, such as a negative electrode current collector or positive electrode current collector material. The electrode current collector material, in some embodiments, may comprise copper, nickel, nickel-coated copper, iron-coated copper, copper-coated aluminum, aluminum, titanium, stainless steel, or other materials known not to alloy with lithium and configured to function as an anode current collector. In another embodiment, the web of base material 104 is a positive electrode current collector material comprising aluminum, aluminum foil, carbon-coated aluminum foil. In such embodiments, the electrode current collector material may be a metal coating as opposed to being a foil, created with standard routes such as electroplating, electroless plating, PVD, metal nanoparticle sintering, and/or sol-gel with post-reduction.

In another embodiment, for example for solid state secondary batteries, the web of base material 104 may comprise a solid state electrolyte material, such as those described in such as those described in U.S. Pat. No. 9,553,332, referenced above. In this embodiment, the web of base material 104 may comprise a fast lithium ion conductor with a conductivity of greater than 10⁻⁵ S/cm, such as garnet, LiPON, antiperovskite, LISICON, thio-LISICON, sulfide, oxysulfide, polymer, composite polymer, ionic liquid, gel, or organic liquid. The electrolyte has a thickness ranging from about 0.1 μm to about 40 μm, but includes variations. In some examples, the electrolyte thickness is 25 μm, i.e., 25 microns. In some examples, the electrolyte thickness is 25 microns (μm) or less.

In another embodiment, for example for solid state secondary batteries, the web of base material 104 may comprise a catholyte material, such as those described in such as those described in U.S. Pat. No. 9,553,332, referenced above. In this embodiment, the web of base material 104 comprises a catholyte material comprising a lithium, germanium, phosphorous, and sulfur (“LGPS”) containing material or a lithium, silicon, phosphorous, and sulfur (“LSPS”) containing material, each of which is configured in a polycrystalline or amorphous state. In this embodiment, the catholyte material has an ion conductivity greater than 10⁻⁴ S/cm and preferably greater than 10⁻³ S/cm.

In one embodiment, the catholyte material has a particle size that is smaller than an active region particle size. For example, the median catholyte particle in some embodiments has a diameter three times or more smaller than the median active particle size. The catholyte material may alternately be configured in a core-shell structure as a coating around the cathode active material. In a further variation, the catholyte material may be configured as nanorods or nanowires. In this embodiment, the web of base material 104 may also include a cathode electronically conducting species such as carbon, activated carbon, carbon black, carbon fibers, carbon nanotubes, graphite, graphene, fullerenes, metal nanowires, super P, and other materials known in the art. The cathode region further comprises a binder material to improve the adhesion of the cathode to the substrate and the cohesion of the cathode to itself during cycling. In an embodiment, the catholyte material has an oxygen species configured within the LGPS or LSPS containing material. In another embodiment, the oxygen species has a ratio to the sulfur species of 1:2 and less to form a LGPSO material or LSPSO material. In an example, the oxygen species is less than 20 percent of the LGPSO material.

In yet other embodiments, the web of base material 104 may be suitable for the production of electrode components for use in solid state secondary batteries, such as those described in U.S. Pat. No. 9,553,33, referenced above wherein the catholyte material is characterized as a solid. In this embodiment, the catholyte material has a substantially fixed compound structure, which behaves like a solid rather than a fluid. In one embodiment, the solid catholyte material is fabricated by physical vapor deposition (PVD), chemical vapor deposition (CVD), atomic layer deposition (ALD), and solid state reaction of powders, mechanical milling of powders, solution synthesis, evaporation, or any combination thereof. In another embodiment, the catholyte material is mixed with the active material in a mixer or mill or with different configurations of physical vapor deposition, optionally mixed with carbon, and coated onto a substrate by gravure, comma coating, meyer rod coating, doctor blading, slot die coating, or with a conventional technique. In another embodiment, the catholyte material is coated directly on cathode active material with a vapor phase growth, mechanofusion, liquid phase growth, deposition on particles in a fluidized bed or rotary reactor, or combinations thereof, or the like. In another embodiment, the web of base material 104 comprises a polymer material comprising a lithium species. The polymer material may be formed overlying the catholyte material. The polymer material in some embodiments is polyacrylonitrile, poly-ethylene oxide, PvDF, PvDF-HFP, rubbers like butadiene rubber and styrene butadiene rubber, among others.

In one embodiment, web of base material 104 may have an adhesive tape layer (not shown) adhered to one or both surfaces of the separator material, the anodically active material layer 508, and/or the cathodically active material layer 512. The adhesive layer may then later be removed subsequent to ablation and cutting (described below) to remove unwanted material or debris.

Embodiments of the laser systems 120a-c used in the production system 100 (FIG. 2) will now be described with reference to FIG. 3, which is an enlarged schematic view of one suitable embodiment of a laser system 120a-120c, indicated at 120 in FIG. 3. The laser systems 120a-c may be referred to collectively herein as a laser system 120. This is for ease of description, and does not limit the laser systems 120a-c to including the same features and components. The laser systems 120a-c may include additional, fewer, or other components, and may be independently operable depending on the laser processing operation performed at each laser system.

As shown in FIG. 3, the web of base material 104 enters the laser system 120 in the down-web direction WD. The web of base material 104 is conveyed across the work platform 306, which may be a stationary chuck 401 (FIG. 4) or a moving work platform 2002 (FIGS. 20-22) that moves continuously with web of base material 104.

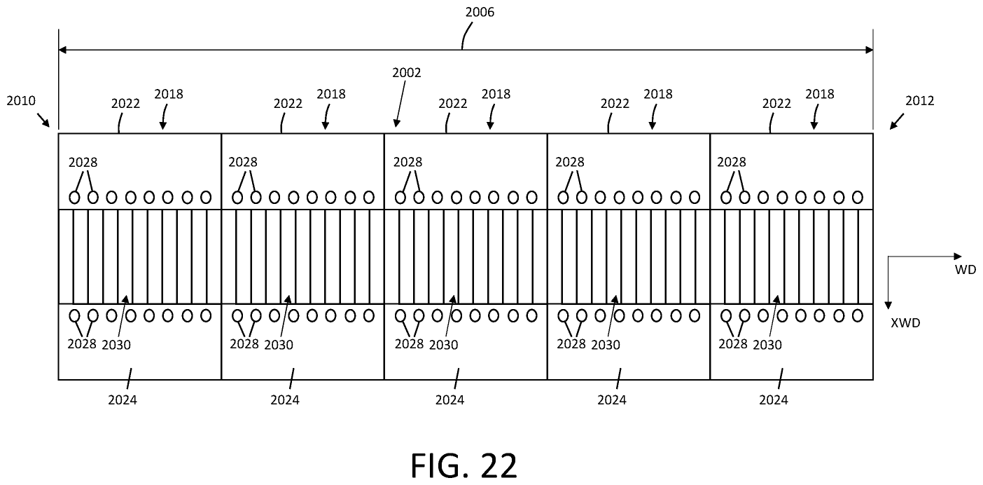

The vacuum 308 is in fluid communication with vacuum openings (e.g., vacuum holes 406 shown in FIGS. 4 and 13 or vacuum holes 2028 shown in FIG. 22) defined in the work platform 306 and draws a vacuum pressure on the web of base material 104 being conveyed over the work platform 306. The vacuum pressure facilitates maintaining the web of base material 104 in a substantially flat/planar state as it is conveyed across the work platform 306. The vacuum openings or holes 406/2028 defined in the work platform 306 may be dimensioned (e.g., sized and/or shape), staggered, and/or chamfered to allow the web of base material 104 to more easily pass thereover without snagging. For example, the vacuum openings may have a cross-sectional area and/or shape that facilitates preventing the web of base material 104 from being drawn therein under vacuum, while also allowing proper airflow from the vacuum therethrough. The cross-sectional shape of the vacuum openings defined in the work platform 306 may be circular, square, rectangular, oval or any other shape that allows the work platform 306 and the vacuum 308 to function as described herein.

A second vacuum may be included in the cutting assembly 304 in addition to the vacuum 308 to equalize the pressure on the web of base material 104 opposite the work platform 306. The equalization in pressure may facilitate maintaining the web of base material 104 in a substantially flat/planar state and at a consistent height when passing over the work platform 306, which facilitates maintaining focus of laser beam 302 on the web of base material 104.

In some embodiments, a carrier web may be used to support the web of base material 104 being conveyed over at least a portion of the production system 100 (e.g., while being conveyed across the work platform 306). The carrier web may be removably attached to the web of base material 104 using a low tack adhesive or electrostatic pinning. In such embodiments, the attachment has sufficient adhesion to remain attached to the web of base material 104 during processing but is removable without causing damage to the web of base material 104. In one embodiment, the carrier web is a material that does not absorb the laser wavelength being used during processing of the web of base material 104 (e.g., via the laser system 120), such that the carrier web will not be cut through, vaporized or ablated, and accordingly may be reused on other webs of base material 104.

The laser system 120 may be sensitive to focus, and as such, it may be critical to keep the web of base material 104 at a substantially constant distance, for example from +/−100 microns of a predetermined position, from laser output 313, to ensure laser beam 302 is in focus when contacting the web of base material 104 during cutting or ablating processes. Accordingly, the vacuum pressure through the vacuum openings defined in the work platform 306 may be monitored and adjusted in real time, for example via user interface 116, to ensure that the web of base material 104 remains substantially flat across the work platform 306 and does not lift or buckle while being processed.

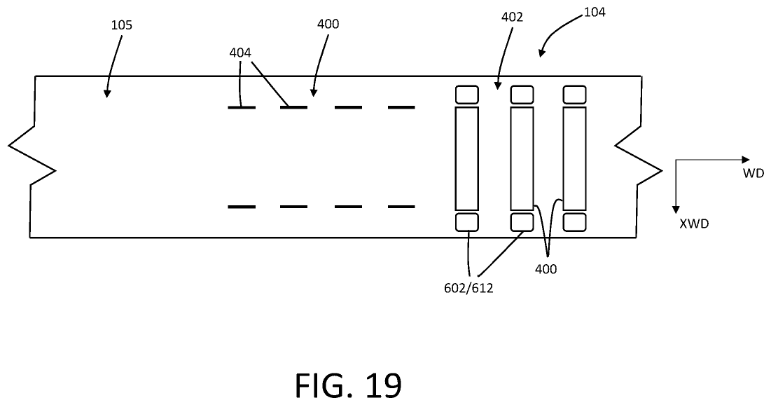

The laser system 120 shown in FIG. 3 may be operable to perform a first cutting action on the web of base material 104. The web of base material 104 may such a laser system 120 in a first condition, having not yet been ablated or cut. Accordingly, the web of base material 104 in the first condition suitably has substantially no defects or alterations from an initial state. A schematic of the web of base material 104 a portion of which is in the first condition is shown in FIG. 19, and the first condition portion of the web of base material 104 is indicated at 105.

One or more laser system(s) 102 may perform a laser ablating action on the web of base material 104 in the first condition 105. The laser ablating action may be performed by laser beam 302 (FIG. 3) to create ablations 404 (FIGS. 4 and 19) in the web of base material 104, such that the web of base material 104 is in a second (laser ablated) condition. FIGS. 4 and 19 depict a portion of the web of base material 104 in the laser ablated condition, indicated at 400. The ablations 404 are created on each side of the web of base material 104, as best shown in FIG. 5. One laser system 120 (e.g., the first laser system 120a shown in FIG. 2) or multiple laser systems 120 may be used to each ablate a portion of the web of base material 104 to each create one or more ablations 404 to increase the throughput of the production system 100.

The ablations 404 may be created to remove a portion of electrode material from the web of base material 104 and exposed an underlying layer of electrode material of the web. For example, in one embodiment, the web of base material 104 may be anode material 502, and the ablations 404 remove the anodically active material layer 508 to expose anode current collector layer 506 (FIG. 5). In another embodiment, the web of base material 104 is cathode material 504, and the ablations 404 remove the cathodically active material layer 512 to expose cathode current conductor layer 510. The ablations 404 may be configured as electrode tabs that are adapted to electrically connect the cathode current collector layer 510 and the anode current collector layer 506 to the positive and negative terminals, respectively, of a secondary battery.

When using the laser system 120 to make the ablations 404 in the web of base material 104, the power of the laser beam 302 may be set to a level that is capable of substantially completely, or completely, removing the coating layer (e.g., the anodically active material layer 508 or cathodically active material layer 512), but will not damage or cut through the current collector layer (e.g., the anode current collector layer 506 or cathode current collector layer 510). In use, the laser beam 302 is controlled, for example via user interface 116, to create the ablations 404 while the web of base material 104 is in motion and being conveyed in down-web direction WD.

Referring again to FIGS. 2 and 3, in another stage of the production system 100, the web of material 104 is conveyed in the down-web direction WD toward another laser system 120 and/or a downstream cutting station of the same laser system 120 used the create the ablations. At this stage, one or more laser cuts or patterns 408 may be created in the web of base material 104 by the laser system 120, such that the web of base material 104 is in a third (laser patterned) condition. FIGS. 4 and 19 depict a portion of the web of base material 104 in the laser patterned condition, indicated at 402. The laser patterns 408 may be individual electrode patterns 800 (FIG. 8), which may also be referred to as an electrode tear pattern or weakened tear pattern. These patterns 408/800 may delineate each member of a population of electrode structures in the web of base material 104.

The patterns 408 may include one or more lengthwise edge cuts 600 (FIG. 6) that define lengthwise edges of an electrode in the cross-web direction XWD of the web of base material 104. The lengthwise edge cuts 600 are cut using the laser beam 302 cutting the web of base material 104 in the cross-web direction XWD while the web of base material 104 is conveyed in the down-web direction WD. The cross-web direction XWD is orthogonal to the down-web direction WD.

As described in further detail below, the patterns 408 may be created by the laser beam 302 while the web of base material 104 is moving in the down-web direction WD. This may be facilitated by the machining apparatus 2000 shown in FIGS. 20-22. In order to create lengthwise edge cuts 600 that extend in the cross-web direction XWD as the web of based material is moving in a substantially perpendicular, down-web direction WD, the laser beam 302 is suitably controlled to travel at an angle with respect to the down-web direction WD. In particular, travel of the laser beam 302 when creating the lengthwise edge cuts 600 may be controlled to account for the movement of the web of base material 104 in the down-web direction WD.

To illustrate, referring to FIGS. 3 and 6, as the web of base material 104 moves in the down-web direction WD, the path of the laser beam 302 is projected onto the web of base material 104 at an initial cut location 604. Travel of the laser beam 302 is controlled to be synchronized with the motion of the web of base material 104 in the down-web direction WD. Accordingly, the path of laser beam 302 is controlled to travel in both the cross-web direction XWD and the down-web direction WD until reaching end cut location 606 to create the lengthwise edge cuts 600. A compensation factor may be applied to the path of the laser beam 302 between the initial cut location 604 and the end cut location 606 to allow cuts to be made in the cross-web direction XWD while the web of base material 104 is continuously traveling in the down-web direction WD. The angle at which the laser beam 302 travels suitably varies based upon the speed of the web of base material 104 in the down-web direction WD. The compensation factor may take into the account the speed of the web of base material 104 in the down-web direction WD to control travel of the laser beam 302 at a suitable angle to create cuts in the cross-web direction XWD.

The laser system 120 may be controlled to account for other parameters of the production system 100 in addition to the speed of the web of base material 104. These parameters may be monitored, stored in the memory of the user interface 116, or provided by an operator during the production process. For example, the laser system 120 may be controlled to adjust the laser beam 302 position to account for the eccentricity of roller(s) of the production system 100 (e.g., one or more of the nip rollers 112, 123, 132) based upon the mapping of the roller(s) described above.

In some embodiments, the web of base material 104 is temporarily stopped during the laser processing operation, and as such, the path of the laser beam 302 does not need to account for the motion of the travel of the web of base material 104 in the down-web direction WD. Such embodiment may be referred to as a step process, or step and repeat process. Step and repeat processes may be used when high precision of the patterns 408 is desired, but slows down the laser processing operation and decreases the throughput of the production system 100. The machining apparatus 2000, described below, may suitably be used to facilitate machining the web of base material 104 moving in the down-web direction WD, increasing the throughput of the production system 100, while also enabling the laser beam 302 to create highly precise patterns 408 in the web of base material 104.

During laser processing, the laser system 120 may use a repeating alignment feature, such as fiducial features 602 to adjust/align the laser beam 302 during the laser processing operations, for example to compensate for possible variations in positioning of the web of base material 104. The fiducial features 602 may be created upstream from the laser system 120 that uses the fiducial features, for example, at an upstream laser system. Alternatively, the fiducial features 602 may be created by any suitable means. For example, the fiducial features 602 may be pre-cut in the web of base material 104 prior to any laser processing operation being performed. In some embodiments, the web of base material 104 may include fiducial features 602 that have been machine punched, or laser cut, prior to being loaded into production system 100. In another suitable embodiment, the fiducial features 602 may be mechanically machine punched subsequently to forming ablations 404 on a first surface of the web of base material 104. In other suitable embodiments, the production system 100 may include one or more additional mechanical punches which may be used to form one or more of the lengthwise edge cuts 600, and/or first and second perforations 608, 610 described below.

In the illustrated embodiments, the laser processing operations as described herein create the lengthwise edge cuts 600 defined in the cross-web direction XWD, such that repeating patterns of individual electrode patterns 800 are aligned in the cross-web direction XWD. In other embodiments, the laser processing operations described herein may be controlled such that the lengthwise edge cuts 600, and all associated cuts, perforations and ablation operations are oriented respectively perpendicular. For example, lengthwise edge cuts 600 can be aligned in the down-web direction WD, such that populations of individual electrode patterns 800 are aligned in the down-web direction WD, rather than the cross-web direction XWD.

In one embodiment, the laser system 120 cuts a tie bar 614 (FIG. 6) between one or more of the individual electrode patterns 800. The tie bar 614 may be used to delineate between groups of the individual electrode patterns 800. For example, in the embodiment shown in FIG. 6, a tie bar 614 is cut between groups of five individual electrode patterns 800. However, in other embodiments the tie bar 614 may be included after any number of individual electrode patterns 800, or not present at all. The tie bar 614 is defined by an upstream and downstream tie bar edge cut 616, 618 respectively. In some embodiments, the tie bar 614 is sized to provide additional structural stiffness to the web of base material 104 during processing.

The laser system 120 may cut one or more repeating alignment features such as a plurality of the fiducial features 602 in the web of base material 104. In one embodiment, the fiducial features 602 are fiducial through-holes. The fiducial features 602 are cut at a known location on the web of base material 104. The fiducial features 602 are shown as circular in FIG. 6, but may be rectangular as shown in FIG. 8, or any size or shape that allows the production system 100 to function as described herein. The fiducial features 602 may be tracked by one or more of visual inspection devices 310, 312 which measures the location and speed of travel of the fiducial features 602. The measurement of the fiducial features 602 may then be used to accurately allow for front to back alignment of the patterns on the web of base material 104 in both the down-web direction WD and cross-web direction XWD.

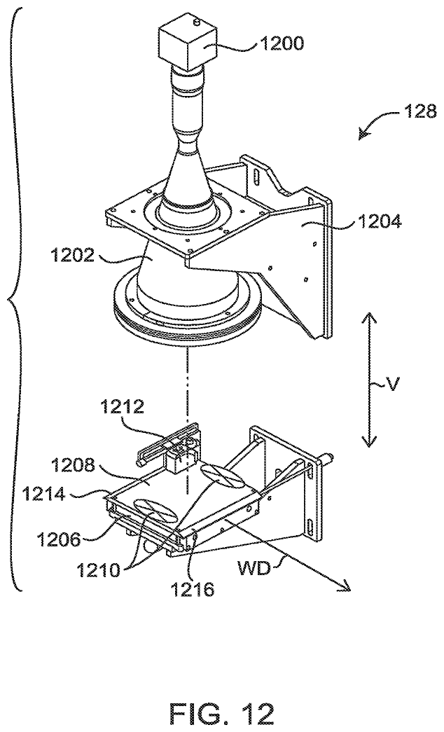

The laser system 120 may also cut a plurality of tractor holes 612 that may be used for alignment of the web of base material 104, or may be used as holes that engage with a gear wheel 1210 (FIG. 12) for positioning and tension control of the web of base material 104. Tractor holes 612 may be circular, square or any other shape that allows the production system 100 to function as described herein. In another suitable embodiments, the web of base material 104 has the plurality of tractor holes 612 and/or fiducial features 602 pre-cut therein prior to being unwound and conveyed through production system 100. In one embodiment, there is a one-to-one ratio of fiducial features 602 to individual electrode patterns 800. In other embodiments, there may be two or more fiducial features 602 per each individual electrode pattern 800.

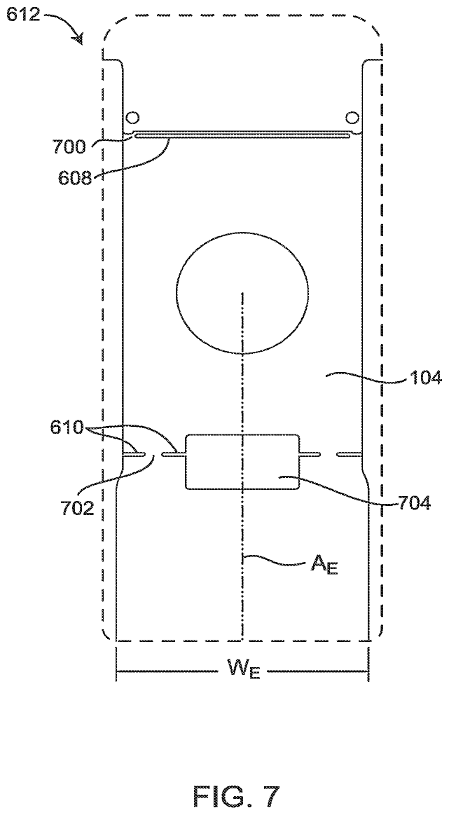

With reference to FIGS. 2, 6, and 7, in one suitable embodiment, the laser system 120 cuts a first perforation 608 and a second perforation 610 in the web of base material 104 as part of the individual electrode pattern 800. The first perforation 608 may also be referred to as the “outer perforation” because it lies at the outside of the individual electrode pattern 800 in the cross-web direction XWD, and the second perforation 610 may also be referred to as the “inner perforation” because it lies inboard of the outer perforation 608 in the cross-web direction XWD. The perforations 608, 610 are best shown in FIG. 7, which is an enlarged view of the portion 613 (FIG. 5) of web of base material 104. First perforation 608 is formed by laser cutting, using laser beam 302, a linear slit (e.g., through-cut) in a direction aligned with the down-web direction WD. Importantly, the first perforation 608 does not extend across the entirety of the width of the electrode W_{E}. Instead, outer tear strips 700 remain on both the upstream and downstream edges of the first perforation 608, to ensure the individual electrode pattern 800 remains connected to the web of base material 104.

Similarly, with further reference to FIGS. 6 and 7, the second perforations 610 are formed inboard (in the cross-web direction XWD) from the first perforations 608. In one suitable embodiment, the second perforations 610 are formed as a line of slits in the down-web direction WD separated by inner tear strips 702. In the embodiment shown, the second perforations 610 intersect through holes 704. In the illustrated embodiment, the inner tear strips 702 are at least two times the length of outer tear strips 700, such that the rupture force required to separate the outer tear strips 700 is approximately half of the rupture force required to separate inner tear strips 702 from the web of base material 104. In other embodiments, the ratio of the rupture strength of the outer and inner tear strips 700 and 702, respectively, may vary, but is preferred that the outer tear strips 700 have a rupture strength lower than the inner tear strips 702, such that upon application of a tensile, or shear, force applied to the edges of the web of base material 104, that the outer tear strips 700 will rupture before inner tear strips 702.

As described above, the laser systems 120a-c may be operable to perform different laser processing operations on the web of base material 104 in the production system 100. The laser system 120a may be configured as a first ablation station and forms the ablations 404 on a first surface of the web of base material 104 in the first condition 105. Upon exiting laser system 120a, the web of base material 104 passes over idler 108d. Idler 108d flips the web of base material 104 in a manner such that a second surface (opposing the first surface) of the web of base material 104 is positioned for processing by the laser system 120b. The laser system 102b may be configured as a second ablation station. The laser system 120b may use the fiducial features 602 to ensure alignment in the down-web direction WD and cross-web direction XWD. Accordingly, the laser system 120b performs a second ablation process on the opposing surface of the web of base material 104, such that ablations 404 on each surface of the web of base material 104 are aligned in the down-web direction WD and the cross-web direction XWD. As described above, current collector tabs of the electrodes may be derived from the ablations 404. The web of base material 104 is in the laser ablated condition 400 upon exiting the laser ablation stations (e.g., the laser systems 102a and 102b in this example).

In one embodiment, the laser system 120c seen in FIG. 2 is configured as a laser cutting station. In this embodiment, the laser system 120c performs the laser cuts such as lengthwise edge cuts 600, and the first and second perforations 608 and 610. The web of base material 104 exiting the laser system 102c is in the laser patterned condition 402.

The laser device 300 of the laser system 120 may be operable at any suitable laser power to enable the laser system 120 to function as described herein. In one suitable embodiment, the laser device 300 of the laser system 120 (e.g., one or more of the laser systems 120a-c) is a 20-watt fiber laser. In other embodiments, the laser device 300 of the laser system 120 may have a laser power within the range of from 10 watts to 5,000 watts, such as from 10 W to 100 W, 100 W to 250 W, 250 W to 1 kW, 1 kW to 2.5 kW, 2.5 kW to 5 kW. Suitable laser devices 300 for use in the laser system 120 may include a laser beam 302 having a wavelength of from 150 nm to 10.6 μm, for example such as from 150 nm to 375 nm, 375 nm to 750 nm, 750 nm to 1,500 nm, and 1,500 nm to 10.6 μm. The laser device 300 may be capable of laser pulse width types of one or more of continuous wave (cw), microsecond (μs), nanosecond (ns), picosecond (ps) and femtosecond (fs) pulse types. Any of these types of lasers may be used alone or in combination as laser devices 300 of laser systems 120a-c. In other suitable embodiments, the laser device 300 is any other laser capable of allowing laser systems 120a-c to perform as described herein.

As described above, the laser system 120 is operable to emit the laser beam 302 toward the work platform 306 of the cutting assembly 304 (FIG. 3) as the web of base material 104 is conveyed across the work platform 306. Details of different cutting assemblies 304 that may be used in the laser system 120 will now be described with references to FIGS. 4 and 13, which show the work platform 306 embodied as a stationary chuck 401, and FIGS. 20-22, which show the cutting assembly 304 embodied as an example machining apparatus 2000 that includes the work platform 2002 continuously moveable along the track 2004. In some embodiments of the production system 100, the stationary chuck 401 and the machining apparatus 2000 may be implemented in any combination. For example, the stationary chuck 401 may be used as the cutting assembly 304 in conjunction with some of the laser systems 120a-120c and the machining apparatus 2000 may be used in conjunction with (or include) other laser systems 120a-120c in the production system 100.

As shown in FIGS. 4 and 13, the chuck 401 defines a support surface over which the web of base material 104 is conveyed during a laser processing operation performed by the associated laser system 120. The chuck 401 includes vacuum holes 406 defined in the support surface. The vacuum 308 is in fluid communication with the vacuum holes 406 and draws a vacuum pressure on the web of base material 104 being conveyed over the chuck 401 to maintain the web of base material 104 in a substantially flat/planar state as it is conveyed across the chuck 401. As described above, the vacuum holes 406 defined in the work platform 306 may be dimensioned (e.g., sized and/or shape), staggered, and/or chamfered to allow the web of base material 104 to more easily pass thereover without snagging and enable the chuck 401 and the vacuum to function as described herein.

The chuck 401 also includes an opening 410 downstream from the vacuum holes 406. The opening 410 is defined by an upstream edge 412 and a downstream edge 414. The chuck 401 may include a chamfer 416 on the downstream edge 414 of the opening 410. The chamfer 416 suitably facilitates the web of base material 104 passing over downstream edge 414 of the opening 410 without having the web of base material 104 catch or snag on the downstream edge 414.

The angle α of the chamfer 416 may be between 1 degree and 90 degrees, such as 5 degrees, 10 degrees, 15 degrees, 20 degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees or any other angle that allows chamfer 416 to function as describes herein. It the illustrated embodiment, for example, the angle α is approximately 25 degrees. Suitably, the angle α of the chamfer 416 is greater than the deflection of the web of base material 104 passing over the chamfer 416.

The opening 410 is defined inboard of a downstream edge of the chuck 401, such that the support surface of the chuck 401 has a portion downstream from the opening 410. An upper edge 418 of chamfer 416 may be radiused to provide a smooth transition from the chamfer 416 to the surface of the chuck 401 downstream from the opening 410.

The chuck 401 may be formed from a thermally conductive material to facilitate dissipating heat from the web of a base material 104 during laser machining performed by the associated laser system 120. In one suitable embodiment, the chuck 401 is formed from aluminum. However, the chuck 401 may be formed from aluminum alloy, composites, metals or metal alloys or any other suitable thermally conductive material that allows chuck 401 to function as described herein.

The cutting area of the chuck 401, which constitutes the area of the chuck 401 at which the laser beam 302 is emitted by the associated laser device 300, includes the opening 410. The opening 410 may enable debris removed from the web of base material 104 during the laser machining to be removed from the surface of the chuck. In particular, by performing the laser machining over the opening 410 (for example, to create the ablations 404, the lengthwise edge cuts 600, the fiducial features 602, and/or the first and second perforations 608, 610) debris is allowed to fall through the opening 410. In some embodiments, the opening 410 is in fluid communication with the vacuum 308, to draw a vacuum pressure on the web of base material 104 passing over the opening 410 and collect debris falling through the opening 410. In one suitable embodiment, the opening 410 is wider in a cross-web direction XWD than the web of base material 104, such that an entire width of the web of base material 104 in the cross-web direction XWD is suspended over the opening 410.

The stationary chuck 401 may limit the speed at which the web of material 104 moves through the laser system(s) 120, and may therefore limit the overall throughput of the production system 100. Typically, the stationary chuck 401 is only suitable for use in a step and repeat laser processing operation in which, as described above, the web of base material 104 is temporarily stopped during the laser processing operation. This may be due to the propensity for the web of base material 104 to snag on the vacuum holes 406 and/or opening 410 of the chuck 401 under vacuum. Thus, during the laser processing operation, the web may be conveyed and temporarily stopped, and the vacuum is applied only when the web is stopped. Additionally and/or alternatively, the stationary chuck 401 limits throughput due to build up over time of debris that is not removed by the opening 410. In particular, operation of the production system 100 may need to be ceased from time to time to remove debris build up from and otherwise clean the surface of the chuck 401.

Referring now to FIGS. 20-22, the machining apparatus 2000 may suitably be implemented in one or more of the laser systems 120a-120c to facilitate increasing throughput of the production system 100 and limiting operational downtime. The machining apparatus 2000 may include, or be used in conjunction with, the laser device 300 of the laser system 120. Although the machining apparatus 2000 will be described with reference to the laser system 120, the machining apparatus may be implemented for use with other components of the production system 100 as well. For example, the machining apparatus 2000 may be used in conjunction with any machining component of the production system 100, such as a machine punch component.

The machining apparatus 2000 includes the work platform 2002 and the track 2004. The track 2004 defines a web path 2006 and an offload path 2008. The web path 2006 is substantially linear in extent and extends in the down-web direction WD. The work platform 2002 extends the entirety of a length of the web path 2006 measured in the down-web direction WD between a first end 2010 of the web path 2006 and a second end 2012 of the web path 2006. The offload path 2008 is defined as the portion of the track 2004 extending from the second end 2012 to the first end 2010 of the web path 2006. The track 2004 extends continuously between the web path 2006 and the offload path 2008. The track 2004 has a racetrack shape in the illustrated embodiment. In other embodiments, the track 2004 may have any suitable continuous shape (e.g., square, rectangle, circle, etc.). The web path 2006 is linear in extent between the first and second ends 2010, 2012, and the offload path 2008 curves or bends in extent to complete the shape of the track 2004.

The web of base material 104 is conveyed toward the work platform 2002 generally in the down-web direction WD. The machining apparatus 2000 may include one or more guide rollers 2014 upstream of the work platform 2002 and web path 2006. The guide rollers 2014 may direct the web of base material 104 toward the work platform 2002 at the first end of the web path 2006. The machining apparatus 2000 also includes end rollers 2016 downstream from the work platform 2002 and the web path 2006. The end rollers 2016 provide an exit path for the web of base material 104 from the work platform at the second end 2012 of the web path 2006. The guide rollers 2014 and the end rollers 2016 may include any suitable type of roller as described herein for use in the production system 100. For example, the rollers 2014 and 2016 may include idlers, dancers, drive rollers, or any combination thereof. The rollers 2014 and 2016 may facilitate controlling tension on the web of base material 104, a conveying speed of the web, and/or a direction of movement of the web.

The work platform 2002 is operably coupled to the track 2004, which continuously moves the work platform 2002 from the first end 2010 to the second end 2012 of the web path 2006 in the down-web direction WD. That is, the work platform 2002 is endlessly moving along the web path 2006 in the down-web direction WD while maintaining its extent between the first and second ends 2010, 2012. Suitably, the work platform 2002 moves in the down-web direction WD along the web path 2006 at the same speed as the conveying speed of the web of base material 104. The conveying speed of the web of base material 104 when the machining apparatus 2000 is implemented in the production system 100 may be any suitable speed to achieve a desired throughput. For example, the conveying speed of the web of base material 104 may be within a range of from 10 mm/sec to 2000 mm/sec.

The track 2004 may be a motorized track to enable movement of the work platform 2002 that is coupled to the track 2004. For example, the track 2004 may be a linear motor track. In the example embodiment, the track 2004 includes four linear motors 2026a-d each positioned along one of the web path 2006 (linear motor 2026a), one of two U-shaped segments of the offload path 2008 (linear motors 2026b,d), and a linear segment of the offload path 2008 opposite the web path (linear motor 2026c). Other means of moving or driving the work platform 2002 along the track 2004 may be used. For example, the track 2004 may include a rotary belt drive, rotary chain drive, one or more rotary gears, one or more rotary actuators, and the like.

The continuous movement of the work platform 2002 is enabled by supports 2018 that are operably coupled to the track 2004. Each support 2018 includes a runner 2020 that is slidingly coupled to and driven by the track 2004. Each runner 2020 may slide or move along the track 2004 using any suitable means. For example, each runner 2020 may include one or more rolling elements (e.g., wheels or ball bearings), that enable movement of the runner 2020 along a peripheral rail of the track 2004. As the runners 2020 move along the track 2004, the runners 2020 transition between an upright position along the web path 2006 and an inverted position along the offload path 2008. The runners 2020 may be maintained on the track 2004 (e.g., prevented from falling in the inverted position) by engagement between the rolling elements and the rail of the track 2004.

The track 2004 operates to move (e.g., drive or translate) the runner 2020 of each of the supports 2018 continuously along the track between the web path 2006 and the offload path 2008. In particular, movement of the runners 2020 is driven by the linear motors 2026a-d located along the track 2004. The linear motor 2026a located along the web path 2006 drives the runners 2020 to move at the conveying speed of the web of base material 104. The linear motors 2026b-d located along the respective segments of the offload path 2008 may drive the runners 2020 to move at a greater speed than the conveying speed of the web to facilitate maintaining continuity of the continuously moving platform 2002.

Each support 2018 also includes a cantilevered plate 2022 secured to and extending from the runner 2020. The plates 2022 of adjacent supports 2018 moving along the web path 2006 define the work platform 2002. FIG. 22 shows a schematic of the plates 2022 of adjacent supports 2018 moving along the web path 2006, where the contiguous plates 2022 form the work platform 2002. Each plate 2022 includes a work surface 2024 that engages the web of base material 104 moving across the work platform 2002 along the web path 2006.

As shown in FIG. 22, each plate 2022 is rectangular in shape, although the plates 2022 may have any suitable shape to enable the plates 2022 to function as described herein. Each plate 2022 also includes vacuum holes 2028 and a grated opening 2030 defined in the work surface 2024. The grated opening 2030 of the contiguous plates 2022 along the web path 2006 align to form a continuous grated opening extending across the work platform 2002. The vacuum holes 2028 of the contiguous plates 2022 also extend across the work platform 2002 adjacent to the continuous grated opening. The grated opening 2030 of each plate may complement a shape of the laser cuts or patterns 408 (FIGS. 4 and 19) created in the web of base material 104 by the laser system 120. For example, the grated opening 2030 may complement a shape of the individual electrode patterns 800 cut or machined into the web (FIG. 8). The web of base material 104 is guided to extend across the vacuum holes 2028 and the grated openings 2030 of the contiguous plates 2022 when moving along the web 2006 in engagement with the work platform 2002.

The vacuum 308 (FIG. 3) is in fluid communication with the vacuum holes 2028 of each plate 2022 as the plate moves along the web path 2006. In particular, a vacuum rail 2032 extends between the first and second ends 2010, 2012 of the web path 2006 and is fluidly connected with the vacuum holes 2028 of the plates 2022 moving along the web path 2006. The vacuum rail 2032 is also fluidly connected with the vacuum 308 via a vacuum duct 2034. The vacuum 308 operates to draw a vacuum pressure through the vacuum rail 2032, which in turn draws a vacuum pressure on each plate 2022 through the vacuum holes 2028. The vacuum pressure drawn on each plate 2022 via the vacuum 308 and vacuum rail 2032 maintains the web of base material 104 in a substantially flat/planar state as it is engaged with the work surface 2024 of each plate 2022. As described above, the vacuum holes 2028 defined in each plate 2022 may be dimensioned (e.g., sized and/or shape) to facilitate preventing the web of base material 104 from being drawn therein under vacuum, while also allowing proper airflow from the vacuum therethrough. Advantageously, unlike the vacuum holes 406 in the stationary chuck 401 (FIGS. 4 and 13), the vacuum holes 2028 move the with the web of base material 104 in the down-web direction WD along the web path 2006. This reduces the propensity for the web of base material 104 to snag within the vacuum holes 2028 during the laser processing operation, because the web of base material 104 moves with the vacuum holes 2028 along the web path 2006 rather than passing over the vacuum holes as it does when the stationary chuck 401 is used. As such, the laser processing operation may be run without temporary stops, increasing throughput of the production system 100.

The vacuum 308 is also in fluid communication with a vacuum chute 2036 located below the work platform 2002. The vacuum 308 may be fluidly connected with the vacuum chute 2036 via the duct 2034. In some embodiments, the vacuum 308 may be in fluidly communication with the vacuum rail 2032 and the vacuum chute 2036 via different ducts. In still other embodiments, multiple vacuums may be included, each in fluid communication with one of the vacuum rail 2032 and the vacuum chute 2036.

The vacuum 308 operates to draw a vacuum pressure through the vacuum chute 2036, which is suitably located below the continuous grated openings 2030 extending across the work platform 2002. The vacuum chute 2036 is also located below or downstream from the laser device 300, adjacent to a cutting area of the machining apparatus 2000. That is, the vacuum chute 2036 is located below the location at which the laser beam 302 is emitted by the associated laser device 300 and acts on the web of base material 104. The web of base material 104 suitable extends across the continuous grated opening 2030. As such, when the laser device 300 acts on the web, debris removed from the web of base material 104 falls through the grated opening 2030 and into the vacuum chute 2036. The vacuum pressure drawn through the vacuum chute 2036 collects debris falling through the opening 2030 and the chute 2036.

Each plate 2022 may be formed from a thermally conductive material to facilitate dissipating heat from the web of a base material 104 during laser machining performed by the laser device 300. In one suitable embodiment, each plate 2022 is formed from aluminum. However, one or more plates 2022 may be formed from aluminum alloy, composites, metals or metal alloys or any other suitable thermally conductive material that allows the plate 2022 to function as described herein.

The vacuum pressure drawn on the work platform 2002 via the vacuum 308 may be controlled by the user interface 116. The vacuum pressure, and flow rate through duct 2034, are controlled to be within a range such that debris is pulled away from the work platform 2002 without creating unnecessary friction between the web of base material 104 and the work platform 2002. For example, the vacuum pressure may be from 0 to 140 inches H₂O, such as 0 in H₂O, 10 in H₂O, 20 in H₂O, 30 in H₂O, 40 in H₂O, 50 in H₂O, 60 in H₂O, 70 in H₂O, 80 in H₂O, 90 in H₂O, 100 in H₂O, 110 in H₂O, 120 in H₂O, 130 in H₂O, and 140 in H₂O. In some embodiments, the flow rate of the vacuum is controlled to be from about 0 to 425 cubic feet per minute (“cfm”), such as 0 cfm, 25 cfm, 50 cfm, 75 cfm, 100 cfm, 125 cfm, 150 cfm, 175 cfm, 200 cfm, 225 cfm, 250 cfm, 275 cfm, 300 cfm, 325 cfm, 350 cfm, 375 cfm, 400 cfm and 425 cfm. In other embodiments, the vacuum pressure and flow rate may be greater than 140 in H₂O and 425 cfm, respectively. Such vacuum pressures and flow rates are, in some embodiments, applicable to all other components of the system 100 using a vacuum.

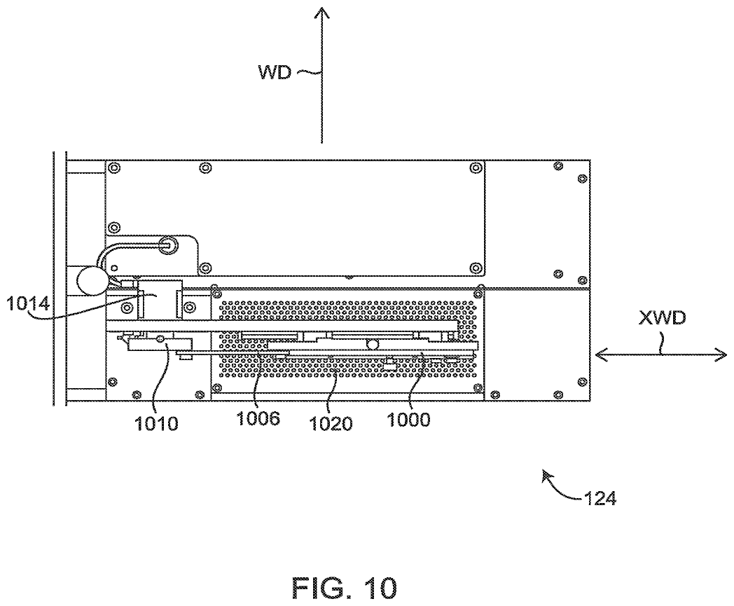

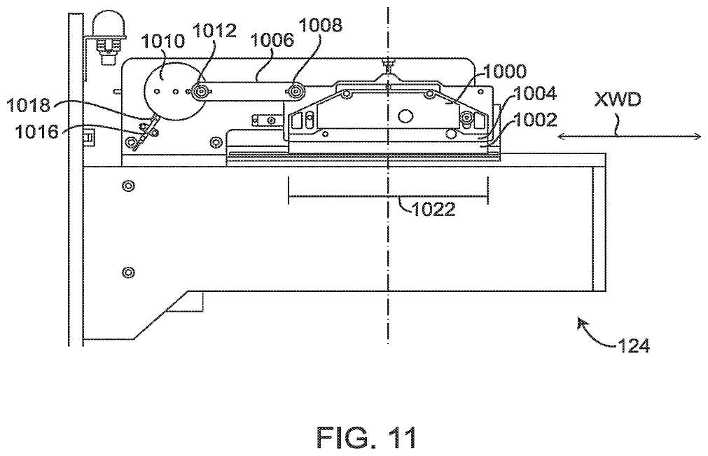

As shown in FIG. 20, the machining apparatus 2000 may also include an inline cleaning station 2038 located along the offload path 2008, downstream from the second end 2012 of the web path 2006. The inline cleaning station 2038 operates to remove remaining debris from the plates 2022 moving along the offload path 2008. The inline cleaning station 2038 may include, for example, a rotating brush (such as brush 1000 shown in FIGS. 10 and 11), an air blower, a vacuum, and the like. The inline cleaning station 2038 may apply a relatively aggressive force on the plates 2022 to remove debris as the web of base material 104 is not engaged with the plates 2022 moving along the offload path 2008. The inline cleaning station 2038 may advantageously prevent against debris build up on the plates 2022, reducing or eliminating the need to stop operation of the production system 100 for intermittent cleaning of the work surfaces 2024 and thereby increasing throughput.

In operation of the machining apparatus 2000, the web of base material 104 is conveyed in the down-web direction WD via the guide rollers 2014 toward the work platform 2002 defined by the contiguous plates 2022 of adjacent supports 2018. The web of base material 104 is directed into engagement with the work platform 2002 at the first end 2010 of the web path 2006 and moves toward the second end 2012 at the conveying speed of the web. The runners 2020 are driven by the linear motor 2026a to move the work platform 2002 at the same conveying speed as the web of base material 104. The web of base material 104 is maintained in engagement with the moving work platform 2002 and in a flat/planar state by the vacuum pressure drawn on the vacuum holes 2028 along the web path 2006. The rollers 2016 may control a tension on the web of base material 104 along the web path 2006. Advantageously, however, tension may not be necessary as the moving supports 2018 facilitate providing a rolling vacuum pressure on the web of base material 104 along the web path 2006 that maintains the flatness of the moving web in the down-web and cross-web directions WD and XWD.

The laser device 300 acts on the web of base material 104 as described above to form desired cuts or patterns in the web. The web of base material 104 continues to move at the conveying speed during the laser processing operation, increasing throughput of the production system 100. As described above, the conveying speed may be selected based on a desired throughput of the production system 100, such as between 10 mm/sec to 2000 mm/sec. Travel of the laser beam 302 when acting on the web (for example, to create the ablations 404, the lengthwise edge cuts 600, the fiducial features 602, and/or the first and second perforations 608, 610) may be controlled to account for the movement of the web of base material 104 in the down-web direction WD at the conveying speed. For example, when creating the lengthwise edge cuts 600, the path of the laser beam 302 is projected onto the web of base material 104 at an initial cut location 604, and travel of the laser beam 302 is controlled to be synchronized with the motion of the web of base material 104 in the down-web direction WD and the path traveled by the laser beam 302 is in both the cross-web direction XWD and the down-web direction WD until reaching end cut location 606 to create the lengthwise edge cuts 600. A compensation factor may be applied to the path of the laser beam 302 between the initial cut location 604 and the end cut location 606 to allow cuts to be made in the cross-web direction XWD while the web of base material 104 is continuously traveling in the down-web direction WD, such that the angle at which the laser beam 302 travels suitably varies based upon the conveying speed of the web of base material 104 in the down-web direction WD. This may facilitate laser machining highly precise patterns in the web of base material 104. Moreover, the rolling vacuum applied to the web of base material 104 by the moving platform 2002, and more particularly the vacuum holes 2028 that move with the web along the web path 2005, may facilitate a consistently precise cut that is typically only achieved in the step and repeat process. For example, the machining apparatus 2000 may be implemented in a laser processing operation of the web of base material 104 to create cuts or patterns in the moving web within tolerances of +/−20 micrometers. Thus, the machining apparatus 2000 facilitates laser processing the moving web at higher throughputs without sacrificing precision of the laser processing.

During the laser processing operation, debris from the laser processing operation falls through the grated openings 2030 and into the chute 2036, and the debris is collected by vacuum pressure drawn therethrough. The web of base material 104 and the work platform 2002 move toward the second end 2012 of the web path 2006. At the second end 2012, the vacuum rail 2032 terminates in extent, and the vacuum pressure drawn through the vacuum holes 2028 ends as a result. The web of base material 104 disengages from the work platform 2002 at the second end 2012 of the web path 2006 via the ends rollers 2016 and is conveyed toward subsequent components of the production system 100 downstream from the machining apparatus 2000.

When each support 2018 reaches the second end 2012 of the web path 2006 and the web of base material 104 disengages the work surface 2024, the linear motors 2026b-d operate to drive the support 2018 along the offload path 2008 of the track 2004. As the support 2018 moves along the offload path 2008, the inline cleaning station 2038 operates to remove any remaining debris from the plate 2022. This reduces or eliminates downtime of the production system 100 otherwise needed for cleaning a work surface of the laser processing operation (e.g., when the stationary chuck 401 is used). The supports 2018 are driven to move at a greater speed along the offload path 2008 than the conveying speed traveled along the web path 2006. This ensures that each support 2018 returns to the first end of the web path 2006 to maintain continuity of the moving work platform 2002.

Upon having exited one or more of laser systems 120a-c, the web of base material 104 may be conveyed to one or more cleaning stations such as brushing station 124 and air knife 126. In one suitable embodiment, the brushing station 124 includes a brush 1000 (FIGS. 10 and 11) that travels in the cross-web direction XWD. The brush 1000 includes a set of bristles 1002 that are held by bristle holder 1004. The brush 1000 is configured to allow bristles 1002 to delicately contact a surface of the web of base material 104 and remove or dislodge any debris therefrom. The contact pressure of the bristles 1002 on the surface of the web of base material 104 must be low enough that it does not break, rupture or otherwise cause defects in the individual electrode patterns 800, and maintains the individual electrode patterns 800 as attached to the web of base material 104. In one embodiment, the normal force between the bristles 1002 and the surface of the web of base material 104 is from 0 to 2 lbs., such as 0.1 lbs., 0.2 lbs., 0.3 lbs., 0.4 lbs., 0.5 lbs., 0.6 lbs., 0.7 lbs., 0.8 lbs., 0.9 lbs., 1.0 lbs., 1.1 lbs., 1.2 lbs., 1.3 lbs., 1.4 lbs., 1.5 lbs., 1.6 lbs., 1.7 lbs., 1.8 lbs., 1.9 lbs., or 2.0 lbs. In other embodiments, the normal force may be greater than 2.0 lbs.

In one embodiment, the length of the bristles 1002 is ¾ inch (19.05 mm). In one embodiment, the bristles 1002 are inserted or clamped within bristle holder 1004 by approximately ⅛ inch. The diameter of the bristles 1002 may be from 0.003 inch (0.076 mm) to 0.010 inch (0.254 mm), such as 0.003 inch (0.076), 0.004 inch (0.101 mm), 0.005 inch (0.127 mm), 0.006 inch (0.152 mm), 0.007 inch (0.177 mm), 0.008 inch (0.203 mm), 0.009 inch (0.228 mm) and 0.010 inch (0.254 mm). In one suitable embodiment, the bristles 1002 are nylon bristles. However, in other embodiments the bristles 1002 may be any other natural or synthetic material that allows the brush 1000 to function as described herein.

With further reference to FIGS. 10 and 11, in one suitable embodiment, to effect movement of the brush 1000 in the cross-web direction XWD, the brush 1000 is connected to crank arm 1006 via a rotatable coupling 1008, such as a bearing, bushing or the like. The crank arm 1006 is rotatably coupled to drive wheel 1010 via a second rotatable coupling 1012. The second rotatable coupling 1012 is coupled to a position off center of the drive wheel 1010, such that the crank arm 1006 oscillates the brush 1000 in a back-and-forth motion in the cross-web direction XWD. The drive wheel 1010 is coupled to a motor 1014 to effect rotation of the drive wheel 1010. A position sensor 1016 senses the position of a brush position marker 1018, which is coupled to the drive wheel 1010. Accordingly, the position sensor 1016 may measure the phase (e.g., angular position) and rotations per time of the drive wheel 1010. In one embodiment, the drive wheel 1010 is controlled to be within a range of 0 to 300 rotations per minute (“rpm”) (e.g., 0 to 300 strokes per minute of brush 1000), such as 0 rpm, 25 rpm, 50 rpm, 75 rpm, 100 rpm, 125 rpm, 150 rpm, 175 rpm, 200 rpm, 225 rpm, 250 rpm, 275 rpm and 300 rpm. In other embodiments, the rpm of drive wheel 1010 may be greater than 300 rpm. It is noted that a constant rpm of drive wheel 1010 will cause a sinusoidal speed variation of brush 1000, due to the crank arm 1006 connection to drive wheel 1010.

In one suitable embodiment, a second brush (not shown) is located in a position to contact the opposing surface of the web of base material 104. In this embodiment, the second brush, which may be substantially the same as the first brush 1000 is configured to travel in a direction opposite to the first brush, and suitably 180 degrees out of phase with the first brush. The phase of the first brush and the second brush may be determined via the position sensor 1016, and an equivalent position sensor of the second brush. In this embodiment, the contact pressure of the bristles 1002 of the first brush 1000 and the second brush, together, must be low enough that it does not break, rupture or otherwise cause defects in the individual electrode patterns 800, and maintains the individual electrode patterns 800 as attached to the web of base material 104.

In one embodiment, the brush 1000 has a brush width 1022 that is wider in the cross-web direction XWD than the width of web of base material 104 in the cross-web direction XWD. For example, in one embodiment, the brush width 1022 is of sufficient width that as the brush 1000 oscillates in the cross-web direction XWD, the bristles 1002 remain in contact with the full width of the surface of the web of base material 104 throughout the entire range of motion of the brush 1000. The rate of oscillation of the brush 1000 and the pressure exerted by the bristles 1002 against the surface of the web of base material 104 may be controlled by the user using the user interface 116.

The brushing station 124 may be equipped with a vacuum system configured to create a vacuum through brush station orifices 1020 to evacuate debris that has been brushed from one or more surfaces of the web of base material 104. In this embodiment, the debris may be brushed from the web of base material 104 and fall, or be suctioned through the brush station orifices 1020. The brush station orifices 1020 are illustrated as being round, but may be any shape that allows brushing station 124 to function as described herein. Further, the upper edges of the brush station orifices 1020 may be chamfered, and/or staggered in position to allow the web of base material 104 to more easily pass over them without having an edge of the web of base material 104 get snagged thereon. In one embodiment, the vacuum level may be controlled to be from 0 to 140 inches H₂O, such as 0 in H₂O, 10 in H₂O, 20 in H₂O, 30 in H₂O, 40 in H₂O, 50 in H₂O, 60 in H₂O, 70 in H₂O, 80 in H₂O, 90 in H₂O, 100 in H₂O, 110 in H₂O, 120 in H₂O, 130 in H₂O, and 140 in H₂O. In some embodiments, the flow rate of the vacuum is controlled to be from about 0 to 425 cubic feet per minute (“cfm”), such as 0 cfm, 25 cfm, 50 cfm, 75 cfm, 100 cfm, 125 cfm, 150 cfm, 175 cfm, 200 cfm, 225 cfm, 250 cfm, 275 cfm, 300 cfm, 325 cfm, 350 cfm, 375 cfm, 400 cfm and 425 cfm. In other embodiments, the vacuum level and flow rate may be greater than 140 in H₂O and 425 cfm, respectively. The vacuum level and flow rate are controlled to be within a range such that debris is pulled away from the web of base material 104 without creating unnecessary friction between the web of base material 104 and the conveying system components. Such vacuum levels and flow rates are, in some embodiments, applicable to all other components of the system using a vacuum.

In another suitable embodiment, one or more of the first brush and the second brush may include a load sensor that measures or monitors the pressure the brush is exerting upon the web of electrode material 802. As shown in FIG. 8, the web of electrode material 802 refers to the web after having been processed as described herein, such that a population of individual electrode patterns 800 have been formed therein. In this embodiment, the first brush and the second brush may be controlled, via user interface 116, to maintain a uniform brushing pressure on the web of electrode material 802 based upon variations in brush bristle wear or electrode thickness or surface roughness.

In another suitable embodiment, one or more of the first brush and the second brush are configured to move at least partially in the down-web direction WD at a rate of speed substantially equivalent to the rate of speed of the web of electrode material 802, thus maintaining a substantially zero speed differential between the brush 1000 and the web of electrode material 802 in the down-web direction WD.

In yet another suitable embodiment, the brushing station 124 may be equipped with a position sensor 1016 to determine the phase of the first brush and the second brush. In one such embodiment, the position sensor 1016 may measure the location of a brush position marker 1018 of the first brush and the second brush. In this embodiment, the position sensor 1016 determines whether the first and second brushes are within a range of predetermined phase difference, such as 180 degrees out of phase, 90 degrees out of phase or zero degrees out of phase or any other suitable phase difference that allows the production system 100 to function as described herein. As used herein, the “phase” of a brush refers to an angular position of a brush, such that the bristles of two separate brushes would be aligned when “in phase.”

In still another embodiment, an ultrasonic transducer (not shown) may be configured to impart ultrasonic vibrations to one or more of the first and second brushes to facilitate debris removal from the web of electrode material 802.

With further reference to FIG. 2, in one suitable embodiment, the web of base material 104 is conveyed through an air knife 126. As used herein, the term air knife refers to a device that uses high pressure air that is blown at the web of base material 104. The high pressure air contacts the surface of the web of base material 104 and removes debris therefrom. The air knife 126 is controlled to supply air at a pressure/velocity such that it does not break, rupture or otherwise cause defects in the individual electrode patterns 800, and maintains the individual electrode patterns 800 as attached to the web of base material 104. In another embodiment, a second air knife (not shown), similar to air knife 126 is configured to blow air at an opposing surface of the web of base material 104 and remove debris therefrom. In this embodiment, the second air knife may blow air in the same direction as the first air knife 126, or in a direction opposite the first air knife 126, or any other direction that allows the air knife 126 to function as described herein. In one embodiment, the air knife 126 station is equipped with a vacuum that facilitates removal of the debris that has been removed by the air knife 126.

With reference to FIG. 8, after having been processed by the laser systems 120a-c and cleaned by the brushing station 124 and the air knife 126, the web of base material 104 exits the cleaning stations as a web containing a plurality of individual electrode patterns 800 within web of base material 104, collectively a web of electrode material 802.

With further reference to FIGS. 2, 8 and 12, in one embodiment, web of electrode material 802 passes through inspection station 128. The inspection station 128 is a device configured to analyze the web of electrode material 802 and identify defects thereon. For example, in one embodiment, the inspection station 128 is a visual inspection device including a camera 1200, which may be a digital camera such as a digital 3-D camera configured to analyze the individual electrode patterns 800 on the web of electrode material 802. In one embodiment, the camera 1200 is a digital light camera including a CMOS having a 48 megapixel sensitivity. The camera 1200 is optically coupled to a lens 1202, which may be a wide field of view lens. In one embodiment, the lens 1202 is a telecentric lens. The lens 1202 is held in place by a lens mount 1204, which in one embodiment may be adjustable in a vertical direction V to control a focus of the lens 1202. The lens 1202 is aimed to focus on the web of electrode material 802 as it passes over inspection plate 1206. In one embodiment, the inspection plate 1206 includes a transparent or semi-transparent top 1208 that allows light from a light source (not shown) housed within the inspection plate 1206 to shine therethrough to generate a backlight. In one suitable embodiment, the intensity and/or color of the light may be controlled via the user interface 116. In one embodiment, one or more additional lighting sources, such as an upstream light and a downstream light illuminate the web of electrode material 802 while within the inspection station 128. In some embodiments, each of the lighting sources are independently controllable for intensity and color. In one embodiment, the backlight includes a diffuse low angle ring light. The web of electrode material 802 may be secured and conveyed over the inspection plate 1206 by gear wheels 1210 that are configured to engage the tractor holes 612 of the web of electrode material 802. In doing so, the web of electrode material 802 is held taught against inspection plate 1206, to substantially eliminate curling of the web of electrode material 802. Each of the inspection plate leading edge 1214 and the inspection plate trailing edge 1216 may be chamfered (e.g., at angles similar to angle α) to allow the web of electrode material 802 to pass smoothly thereover without snagging.

With continued reference to FIG. 12, in one embodiment, the inspection station 128 includes a trigger sensor 1212 that detects a predetermined feature of the web of electrode material 802, such as a fiducial feature 602, lengthwise edge cut 600 or any other feature that allows inspection station 128 to function as described herein. Upon detection of the predetermined feature, the trigger sensor 1212 sends a signal directly to camera 1200 or indirectly through the user interface 116, to trigger the camera 1200 to image an electrode of the web of electrode material 802. Upon imaging the electrode, camera 1200 may be configured to detect one or more metrics such as a height of the electrode, a size or shape of a feature that has been cut by one of the laser systems 120a-120c (FIG. 2), the pitch (distance) between electrodes or any other feature that allows the inspection station 128 to function as described herein. For example, in one suitable embodiment, the inspection station 128 detects whether the ablations 404 (FIG. 4), lengthwise edge cuts 600, fiducial features 602, tractor holes 612, pitch between individual electrode patterns 800, offset in the cross-web and web direction of tractor holes 612, and first and second perforations 608, 610 (FIG. 6) are within a predefined tolerance of size, shape, placement and orientation. In one suitable embodiment, a user may control which feature to inspect using the user interface 116.

In one embodiment, the web of electrode material 802 is held substantially flat during analysis by the inspection station 128, such as by use of application of balanced vacuum or fluid (e.g., air) flow over the opposing sides of the web of electrode material 802. In this embodiment, by having the web of electrode material 802 be flat during inspection, more precise imaging and analysis may be conducted on the web of electrode material 802, and thus higher quality error and defect detection is enabled.

In one embodiment, the inspection station 128 may be configured to provide in-line metrology of the web of base material 104 and/or web of electrode material 802. For example, the inspection station 128 may be configured to measure metrics such as web thickness, sizes and shapes of the individual electrode patterns 800, and the like while the web is being conveyed in the down-web direction WD. These metrics may be transmitted to the user interface 116 for viewing or memory storage, or otherwise used to adjust production parameters of the production system 100.

In one embodiment, in the event the inspection station 128 determines a defect is present on the web of electrode material 802 (FIG. 8), the defect marking system 130 (FIG. 2) will mark the web of electrode material 802 to identify such defect. The defect marking system 130 may be a laser etching device, printer, stamper or any other marking device capable of placing a mark indicating a defect is present on a web of electrode material 802. In another suitable embodiment, the defect marking system 130 is controllable to mark the web of electrode material 802 with one or more of an identification number (ID) and known good electrodes (KGEs), allowing for the possibility to further mark the web of electrode material 802 with a grade, such as grade A, grade B, grade C or the like, indicating a quality measurement (such as number or type of defects) of a particular electrode within the web of electrode material 802.

Upon the processing (also referred to as machining) of the web of base material 104 into the web of electrode material 802, the web of electrode material 802 has a web strength reduction in the down-web direction WD of from 25 percent to 90 percent as compared to the unprocessed (also referred to as unmachined) web of base material 104. With reference to FIG. 8A, a portion of the web of electrode material 802 is shown. In this embodiment, the web of electrode material 802 includes electrode clusters EC comprising five individual electrode patterns 800 separated by a tie bar 614. However, it should be understood that in other embodiments, the electrode cluster EC may include any number of individual electrode patterns 800 including one or more, such as for example, 2, 3, 4, 5, 6, 7, 8, 9, 10, 11, 12, 13, 14, 15, 16, 17, 18, 19, 20 or any other number of individual electrode patterns 800 between tie bars 614. A distance of electrode cluster width W_{EC} is defined as a distance in the down-web direction WD between a center-point of a first individual electrode pattern 800 of an electrode cluster EC to a center-point of a first individual electrode pattern 800 in a second electrode cluster EC.

In an exemplary embodiment, the cross-web span of the web S_{W} is 3X mm in the cross-web direction and a width W_{EP} of each individual electrode pattern 800 in the down-web direction WD is X mm. In this embodiment, the reduction in web strength of the web of electrode material 802 in the down-web direction WD is 33 percent as compared to the unprocessed web of base material 104. The reduction in web strength is calculated as the width W_{EP} divided by the cross-web span S_{W} (i.e., X mm/3X mm=0.33).

In another exemplary embodiment, the cross-web span of the web S_{W} is 1.5X mm in the cross-web direction and a width W_{EP} of each individual electrode pattern 800 in the down-web direction WD is 1.3X mm. In this embodiment, the reduction in web strength of the web of electrode material 802 in the down-web direction WD is 87 percent as compared to the unprocessed web of base material 104. The reduction in web strength is calculated as W_{EP}/S_{W} (i.e., 1.3X/1.5X=0.87). Web strength of the web of electrode material 802 in the down-web direction WD is verified and measured as a breaking strength of the web of electrode material 802 using an electromechanical or hydraulic material tester with at least force feedback, and may include displacement feedback, such as an Instron brand testing machine.

In another exemplary embodiment, there is a strength reduction in the cross-web direction XWD of the web of electrode material 802 as compared to the web of base material 104. In a first exemplary embodiment, the electrode cluster width W_{EC} is 6X mm in the down-web direction WD, the width W_{TB} of the tie bar 614 is X mm in the down-web direction WD and the width W_{EP} of the individual electrode pattern 800 is X mm in the down-web direction WD and the length L_{E} of the individual electrode pattern 800 is 1.7X mm in the cross-web direction XWD. In this embodiment, the reduction in strength of the web of electrode material 802 in the cross-web direction XWD is about 77 percent as compared to the unprocessed web of base material 104. In another exemplary embodiment, the electrode cluster width W_{E}C is 10X mm, the width W_{T}B of the tie bar 614 is 0X mm (i.e., no tie bar 614) and the width W_{EP} of the individual electrode patterns 800 is 2X mm and the length L_{E} of the individual electrode pattern 800 is 1.7X mm. In this embodiment, the reduction in strength of the web of electrode material 802 in the cross-web direction XWD is about 92 percent as compared to the unprocessed web of base material 104. Web strength in the cross-web direction XWD is verified and measured as a breaking strength of the web of electrode material 802 using an electromechanical or hydraulic material tester with at least force feedback, and may include displacement feedback, such as an Instron brand testing machine.

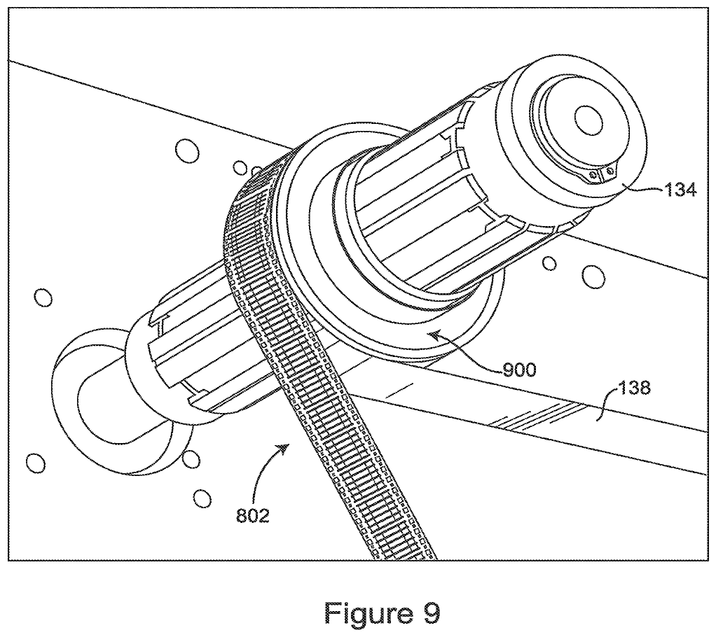

With further reference to FIG. 9, the web of electrode material 802 is then conveyed to the rewind roller 134, where it is wound together with a web of interleaf material 138 to create a spool 900 having alternating layers of web of electrode material 802 and web of interleaf material 138.

In use, with reference to FIG. 2, the base unwind roller 102 of production system 100 is loaded with a web of base material 104. The web of base material 104 is passed across an edge guide 106, to facilitate unwinding of the web of base material 104. In this embodiment, the web of base material 104 is then passed around the idler 108a and into the splicing station 110. The idler 108a is used to facilitate maintaining proper positioning and tension of the web of base material 104, as well as to change the direction of the web of base material 104. The idler 108a receives the web of base material 104 in the vertical direction, and the web of base material 104 is partially wrapped around the idler 108a such that the web of base material 104 leaves the idler 108a in an output direction substantially ninety degrees from the input direction. However, it should be appreciated that the input and output directions may vary without departing from the scope of this disclosure. In some embodiments, the production system 100 may use multiple idlers 108a-108x to change the direction of the web of base material 104 one or more times as it is conveyed through the production system 100. In this embodiment, the user unwinds the web of base material 104 through the idlers 108a-108x, for example as shown in FIG. 2.

In one embodiment, the splicing station 110 is used to splice two separate webs together. In this embodiment, a first web of base material 104 is unwound, such that a trailing edge (not shown) of the first web of base material 104 is stopped within the splicing station 110, and a leading edge (not shown) of a second web of base material 104 is unwound into the splicing station 110 such that the trailing edge of the first web and the leading edge of the second web are adjacent one another. The user then applies an adhesive, such as an adhesive tape, glue, or other suitable adhesive to join the leading edge of the second web to the trailing edge of the first web to form a seam between the two webs and create a continuous web of base material 104. Such process may be repeated for numerous webs of base material 104, as dictated by a user.

In one suitable embodiment, upon exiting the splicing station 110, the web of base material 104 is conveyed in the down-web direction WD to the nip roller 112. The nip roller 112 is controlled via user interface 116 to adjust/maintain the speed at which the web of base material 104 is conveyed through the production system 100. The web of base material 104 is pressed against each of the two adjacent rollers 114 of nip roller 112, with enough pressure to allow friction of the rollers to move the web of base material 104, but a low enough pressure to avoid any significant deformation or damage to the web of base material 104.

In one embodiment, during use, the speed of the web of base material 104 is controlled by controlling the rate of rotation of the high friction roller of nip roller 112 via user interface 116. In other embodiments, the production system 100 may include one or more additional nip rollers 122, 132 to facilitate control of the speed of the web of base material 104, and the web of base material 104 is conveyed therethrough. In this embodiment, the speed of the additional nip rollers 122, 132 may be controlled via user interface 116. In use, when multiple nip rollers 112, 122, 132 are used, each of the speed of each of the nip rollers 112, 122, 132 may be set via user interface 116 to the same speed, or different speeds as required, such that the web of base material 104 is conveyed smoothly through production system 100.

In use, in one embodiment, the web of base material 104 is unwound through the dancer 118. In this embodiment, the pair of rollers of the dancer 118 rotates about the central axis thereof, to passively adjust the tension on the web of base material 104.

With further reference to FIG. 2, in use the web of base material 104 is conveyed through one or more laser systems 120a, 120b, 120c. The embodiment shown in FIG. 2 includes three laser systems 120a-c, but it should be appreciated that any number of laser systems 120 may be used to allow the production system 100 to function as described herein.

Use of the production system 100 is further described with additional reference to FIGS. 2-6 and 19-22. The web of base material 104 is conveyed through the laser systems 120a-c in the down-web direction WD. In one embodiment, the web of base material 104 is conveyed into laser system 120a in the first condition 105 (FIG. 19), having not yet been ablated or cut.

In example embodiments, the web of base material 104 is conveyed toward the moving work platform 2002 (FIGS. 20-22), and brought into engagement therewith at the first end 2010 of the web path 2006 of the machining apparatus 2000. The web of base material 104 is held in engagement with the work platform 2002 and maintained in a flat/planar state via the vacuum holes 2028 in fluid connection with the vacuum 308. In particular, the vacuum 308 is controlled via user interface 116 to draw a vacuum pressure on the web of base material 104 in engagement with the work platform 2002 via the vacuum holes 2028. The vacuum pressure is controlled to maintain the web of base material 104 in a substantially flat/planar state as it is conveyed across the web path 2006. In one embodiment of use, the vacuum pressure through vacuum holes 2028 is monitored and adjusted in real time, via user interface 116, to ensure that the web of base material 104 remains substantially flat across the web path 2006 and does not lift or buckle while being processed. The work platform 2002 and the web of base material 104 remain engaged and move across the web path 2006 at the conveying speed.

With further reference to FIGS. 3, 5, and 19, in one embodiment of use, the web of base material 104 is ablated by laser beam 302 (FIG. 3) to create the ablations 404 (FIG. 19) in the web of base material 104. In one embodiment, the web of base material 104 is anode material 502, and the ablations 404 remove the anodically active material layer 508 to expose anode current collector layer 506 (FIG. 5). In another embodiment, the web of base material 104 is cathode material 504, and the ablations 404 remove the cathodically active material layer 512 to expose cathode current collector layer 510.

During use, when using the laser system 120a to make the ablations 404 in the web of base material 104, the power of the laser beam 302 is controlled via user interface 116 to a level that is capable of substantially completely, or completely, removing the coating layer, but will not damage or cut through the current collector layer. In use, the laser beam 302 is controlled, for example via user interface 116, to create the ablations 404 while the web of base material 104 is in motion and being conveyed in down-web direction WD. The laser beam 302 is controlled such that ablations 404 are created on each lateral side of the web of base material 104, as best shown in FIG. 5.

In one embodiment of use, after making the ablations 404, the laser system 120a is controlled to cut fiducial features 602 in the web of base material 104, as described further herein. In some embodiments, multiple lasers are used to each ablate a portion of the web of base material 104 to each create one or more ablations 404 to increase the throughput of the production system 100.

With further reference to FIGS. 2, 3 and 20, in another stage of use of the production system 100, the web of base material 104 is conveyed in the down-web direction WD toward the cutting location at which the laser beam 302 is emitted by the associated laser device 300 of the machining apparatus 2000 and acts on the web of base material 104. In this embodiment the vacuum chute 2036 is located below the cutting location and the grated opening 2030 (FIG. 22) defined in the work platform 2002, and the chute 2036 is in fluid communication with the vacuum 308. The vacuum 308 is controlled to draw a vacuum pressure on the web of base material 104 as it passes over the grated opening 2030 and the chute 2036 to remove debris from the laser processing operation. In this embodiment, the vacuum drawn through the vacuum holes 2028 may provide an equalization in pressure in the cross-web direction XWD, which may be monitored and controlled to maintain the web of base material 104 in a substantially flat/planar state and at a consistent height as it passes across the cutting location and over the chute 2036, to facilitate focus of laser beam 302 on the web of base material 104.

In one embodiment of use, the laser system 120a is controlled to cut one or more patterns in the web of base material 104 while the web of base material 104 is over the chute 2036. With reference to FIG. 6, the laser system 120 is controlled to cut one or more lengthwise edge cuts 600 to define lengthwise edges of an electrode in the cross-web direction XWD. The lengthwise edge cuts 600 are cut using laser beam 302 by cutting the web of base material 104 in the cross-web direction XWD while the web of base material 104 is conveyed in the down-web direction WD. For example, in one embodiment, the path motion of laser beam 302 is controlled and/or synchronized with the motion of the web of base material 104 in the down-web direction WD. Accordingly, the path of the laser beam 302 travels at an angle with respect to the down-web direction WD, to account for the movement of the web of base material 104 in the down-web direction WD. In this embodiment, a compensation factor is applied to the path of the laser beam 302 to allow cuts to be made in the cross-web direction XWD while the web of base material 104 is continuously traveling in the down-web direction WD. In this embodiment, as the web of base material 104 moves in the down-web direction WD, the laser beam 302 is projected onto the web of base material 104 at an initial cut location 604, and then is controlled to travel in both the cross-web direction XWD and the down-web direction WD until reaching end cut location 606 to create the lengthwise edge cuts 600. The angle at which the laser beam 302 is controlled to travel varies based upon the speed of the web of base material 104 in the down-web direction WD.

With further reference to FIG. 6, in one embodiment of use, the laser system 120a is controlled to cut one or more of the repeating alignment features such as a plurality of fiducial features 602 in the web of base material 104. The fiducial features 602 are cut at a predetermined/known location on the web of base material 104. In one embodiment of use, the fiducial features 602 are tracked by one or more of the visual inspection devices 310, 312 to measure the location and speed of travel of the web of base material 104. The measurement of the fiducial features 602 is then used to accurately maintain front to back alignment of the patterns on the web of base material 104 in both the down-web direction WD and cross-web direction XWD. In some embodiments of use, the laser system 120a cuts the plurality of tractor holes 612 and/or fiducial features 602. In other embodiments, the fiducial features 602 have been pre-formed into the web of base material 104 such that one or more of laser systems 120a-c uses them for positioning/alignment as described above.

With reference to FIGS. 2 and 6, in one suitable embodiment of use, the laser system 120a is controlled to cut a first perforation 608 and a second perforation 610 in the web of base material 104 as part of the individual electrode pattern 800 as the web of base material 104 is in motion in the down-web direction WD. First perforation 608 is formed by laser cutting using laser beam 302. The first perforation 608 is formed as a linear slit (e.g., through-cut) in a direction aligned with the down-web direction WD. Importantly, the first perforation 608 is cut such that it does not extend across the entirety of the width of the electrode W_{E}. Instead, the laser system 120a is controlled to cut the patterns such that outer tear strips 700 remain on both the upstream and downstream edges of the first perforation 608, to ensure the individual electrode pattern 800 remains connected to the web of base material 104.

With further reference to FIGS. 6 and 7, in use, the second perforations 610 are cut inboard (in the cross-web direction XWD) from the first perforations 608. In this embodiment of use, second perforations 610 are cut as a line of slits in the down-web direction WD separated by inner tear strips 702. In the embodiment shown, the second perforations 610 are cut to intersect through holes 704. In the illustrated embodiment, the inner tear strips 702 are cut to be at least two times the length of outer tear strips 700, but may be cut at different lengths as to allow the production system 100 to function as described herein.

In use, with reference to FIGS. 3, 6, and 20-22, debris from the laser cuts for the lengthwise edge cuts 600, the fiducial features 602, and the first and second perforations 608, 610 is allowed to fall through the grated opening 2030 and into the vacuum chute 2036, and the vacuum 308 is controlled to collect debris formed during the laser cutting process.

In one suitable embodiment of use, the laser system 120a is configured as a first ablation station. In this embodiment, the laser system 120a is controlled to form the ablations 404, as described above on a first surface of the web of base material 104. Upon exiting laser system 120a, the web of base material 104 is conveyed over idler 108d to flip the web of base material 104 in a manner such that a second surface (opposing the first surface) of the web of base material 104 is positioned for processing by the laser system 120b. In this embodiment, laser system 120b is configured as a second ablation station and uses the fiducial features 602 to ensure alignment of the ablations 404 in the down-web direction WD and cross-web direction XWD. Accordingly, the laser system 120b is controlled to perform a second ablation process on the opposing surface of the web of base material 104, such that ablations 404 on each surface of the web of base material 104 are aligned in the down-web direction WD and the cross-web direction XWD.

In one embodiment of use, the laser system 120c shown in FIG. 2 is configured as a laser cutting station. In this embodiment, the laser system 120c is controlled to perform the laser cuts for lengthwise edge cuts 600, and the first and second perforations 608 and 610.

With further reference to FIGS. 2, 10 and 11, in one embodiment of use, the web of base material 104 is then conveyed through one or more cleaning stations, such as brushing station 124 and air knife 126 upon having exited one or more of laser systems 120a-c. In one suitable embodiment of use, the web of base material 104 is conveyed through brushing station 124, and bristles 1002 are controlled to delicately contact a surface of the web of base material 104 and remove or dislodge any debris therefrom. The contact pressure of the bristles 1002 on the surface of the web of base material 104 is controlled to be low enough that it does not break, rupture or otherwise cause defects in the individual electrode patterns 800, and maintains the individual electrode patterns 800 as attached to the web of base material 104.

With further reference to FIGS. 10 and 11, in one suitable embodiment of use, brush 1000 is controlled to move in the cross-web direction XWD by controlling the motor 1014 to effect rotation of the drive wheel 1010. A position sensor 1016 is controlled to sense the position of the brush position marker 1018 to measure the phase (e.g., angular position) and rotations per time of the drive wheel 1010.

In one suitable embodiment of use, a second brush (not shown) is controlled to contact the opposing surface of the web of base material 104. In this embodiment, the second brush, which may be substantially the same as the first brush 1000 is controlled to travel in a direction opposite to the first brush 1000, and suitably 180 degrees out of phase with the first brush 1000. The phase of the first brush 1000 and the second brush may be monitored via the position sensor 1016, and an equivalent position sensor of the second brush. In this embodiment, the contact pressure of the bristles 1002 of the first brush 1000 and the second brush, together, is controlled to be low enough that it does not break, rupture or otherwise cause defects in the individual electrode patterns 800, and maintains the individual electrode patterns 800 as attached to the web of base material 104.

In use, the rate of oscillation of the brush 1000 and the pressure exerted by the bristles 1002 against the surface of the web of base material 104 may be controlled by the user using the user interface 116.

In one embodiment of use, the brushing station 124 is equipped with a vacuum system and controlled to create a vacuum through brush station orifices 1020 to evacuate debris that has been brushed from one or more surfaces of the web of base material 104. In this embodiment, the debris is brushed from the web of base material 104 and falls, or is suctioned through the brush station orifices 1020.

In another suitable embodiment of use, one or more of the first brush 1000 and the second brush include a load sensor that is measured or monitored to determine the pressure the brush 1000 is exerting upon the web of electrode material 802. In this embodiment, the first brush 1000 and the second brush are controlled, via the user interface 116, to maintain a substantially uniform brushing pressure on the web of electrode material 802 based upon variations in brush bristle wear or electrode thickness or surface roughness.

In another suitable embodiment of use, one or more of the first brush 1000 and the second brush are controlled to move at least partially in the down-web direction WD at a rate of speed substantially equivalent to the rate of speed of the web of electrode material 802, to maintain a substantially zero speed differential between the brush 1000 and the web of electrode material 802 in the down-web direction WD.

In yet another suitable embodiment of use, the brushing station 124 is equipped with a position sensor 1016 that determines the phase of the first brush 1000 and the second brush. In this embodiment, the position sensor 1016 measures the location of the brush position marker 1018 of the first brush 1000 and the second brush. In this embodiment, the position sensor 1016 determines whether the first and second brushes are within a range of predetermined phase difference, such as 180 degrees out of phase, 90 degrees out of phase or zero degrees out of phase or any other suitable phase difference that allows the production system 100 to function as described herein, and allows for correction thereof or provides an alert to the user via user interface 116 or other alert device that the brushes are not properly phased.

In still another embodiment of use, an ultrasonic transducer (not shown) is activated to impart ultrasonic vibrations to one or more of the first and second brushes to facilitate debris removal from the web of electrode material 802.

With further reference to FIG. 2, in one suitable embodiment of use, the web of base material 104 is conveyed through an air knife 126. In this embodiment, high pressure air is controlled to contact the surface of the web of base material 104 to remove debris therefrom. The air knife 126 is controlled, for example via user interface 116, to supply air at a pressure/velocity such that it does not break, rupture or otherwise cause defects in the individual electrode patterns 800, and maintains the individual electrode patterns 800 as attached to the web of base material 104. In another embodiment, a second air knife is controlled to blow air at an opposing surface of the web of base material 104 to remove debris therefrom. In this embodiment, the second air knife is controlled to blow air in the same direction as the first air knife 126, or in a direction opposite the first air knife, or any other direction that allows the air knife 126 to function as described herein. In another embodiment, the air knife 126 is equipped with a vacuum that is controlled to facilitate removal of the debris that has been removed by the air knife 126.

With reference to FIG. 8, after having been processed by the laser systems 120a-c and cleaned by the brushing station 124 and the air knife 126, the web of base material 104 exits the cleaning stations as a web containing a plurality of individual electrode patterns 800 within web of base material 104, collectively the web of electrode material 802.

With further reference to FIGS. 2, 8 and 12, in one embodiment of use, the web of electrode material 802 is conveyed through inspection station 128. The inspection station 128 is controlled to analyze the web of electrode material 802 and identify defects thereon. For example, in one embodiment, the inspection station 128 is a visual inspection device including the camera 1200. The lens 1202 is aimed to focus on the web of electrode material 802 as it passes over inspection plate 1206. In one embodiment of use, the inspection plate 1206 includes the transparent or semi-transparent top 1208 that allows light from a light source (not shown) housed within the inspection plate 1206 to shine therethrough. In one suitable embodiment, the intensity and/or color of the light is controlled via the user interface 116. In one embodiment of use, the web of electrode material 802 is conveyed over the inspection plate 1206 by gear wheels 1210 that engage the tractor holes 612 of the web of electrode material 802. In doing so, the web of electrode material 802 is held taught against inspection plate 1206, to substantially eliminate curling of the web of electrode material 802.

With additional reference to FIG. 12, in one embodiment of use, the inspection station 128 includes a trigger sensor 1212 that is controlled to detect a predetermined feature of the web of electrode material 802, such as a fiducial feature 602, lengthwise edge cut 600 or any other feature that allows inspection station 128 to function as described herein. Upon detection of the predetermined feature, the trigger sensor 1212 sends a signal directly to camera 1200 or indirectly through the user interface 116, to trigger the camera 1200 to image an electrode of the web of electrode material 802. Upon imaging the electrode, camera 1200 is controlled to detect one or more metrics such as a height of the electrode, a size or shape of a feature that has been cut by one of the laser systems 120a-120c (FIG. 2), the pitch (distance) between electrodes or any other feature that allows the inspection station 128 to function as described herein. For example, in one suitable embodiment, the inspection station 128 is controlled to detect whether the ablations 404 (FIG. 4), lengthwise edge cuts 600, fiducial features 602, and first and second perforations 608, 610 (FIG. 6), individual electrode structure cross-web direction XWD dimensions, individual electrode structure down-web direction WD dimensions, individual electrode active area offset, and any other ablation or cut of web of electrode material 802 are within a predefined tolerance of size, shape, placement, cross-machine direction pitch, machine direction pitch, and orientation, and presents this information to the user via user interface 116. In one suitable embodiment, a user may control which feature to inspect using the user interface 116. In yet another embodiment, inspection station 128 may detect a cluster identification code for one or more electrode structures of the web of electrode material 802.

In one embodiment of use, the inspection station 128 is used to provide in-line metrology of the web of base material 104 and/or web of electrode material 802. In this embodiment, the inspection station 128 is controlled to measure metrics such as web thickness, sizes and shapes of the individual electrode patterns 800, and the like while the web is being conveyed in the down-web direction WD. These metrics are transmitted to the user interface 116 for viewing or memory storage, or otherwise used to adjust production parameters of the production system 100.

In one embodiment of use, if the inspection station 128 determines a defect is present on the web of electrode material 802 (FIG. 8), the defect marking system 130 (FIG. 2) is controlled to mark the web of electrode material 802 to identify such defect using a laser etching device, printer, stamper or any other marking device capable of placing a mark indicating a defect is present on a web of electrode material 802. In another suitable embodiment of use, the defect marking system 130 is controlled to mark the web of electrode material 802 with one or more of an identification number (ID) and known good electrodes (KGEs), allowing for the possibility to further mark the web of electrode material 802 with a grade, such as grade A, grade B, grade C or the like, indicating a quality measurement (such as number or type of defects) of a particular individual electrode pattern 800 within the web of electrode material 802.

With further reference to FIG. 9, the web of electrode material 802 is then conveyed to the rewind roller 134, where it is wound together with web of interleaf material 138 to create a spool 900 having alternating layers of web of electrode material 802 and web of interleaf material 138.

In one suitable embodiment of use, the web of electrode material 802 is rewound via a rewind roller 134 together with a web of interleaf material 138, which is unwound via interleaf roller 136 to create a roll of electrodes 140 with layers of webs of electrode material 802 separated by webs of interleaf material 138. In some embodiments, the web of electrode material 802 is rewound via the rewind roller 134 without the web of interleaf material 138.

In one embodiment of use, web of base material 104 has an adhesive tape layer (not shown) adhered to one or both surfaces of the anodically active material layer 508, or cathodically active material layer 512, respectively. In this embodiment, in use, the adhesive layer is removed subsequent to the ablation and cutting (described above) to remove unwanted material or debris.

In one embodiment of use, one or more of the rollers of the conveyor system is not perfectly round, such that the roller has an eccentricity. In such embodiment, the eccentric roller(s) are mapped to determine the radius versus radial position. The laser system 120a-c is then controlled to adjust the laser beam 302 position to account for the eccentricity based upon the mapping of the roller(s).

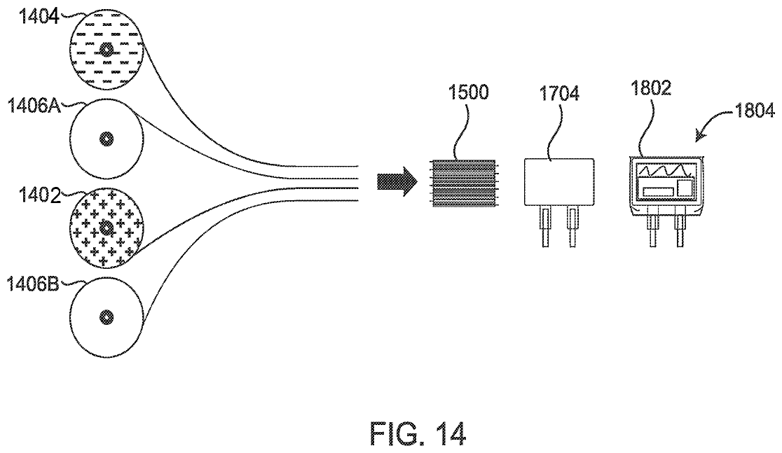

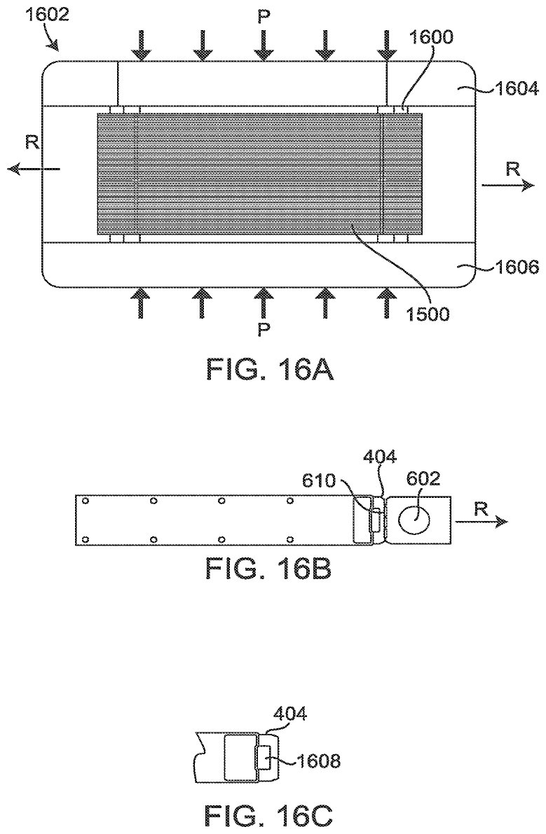

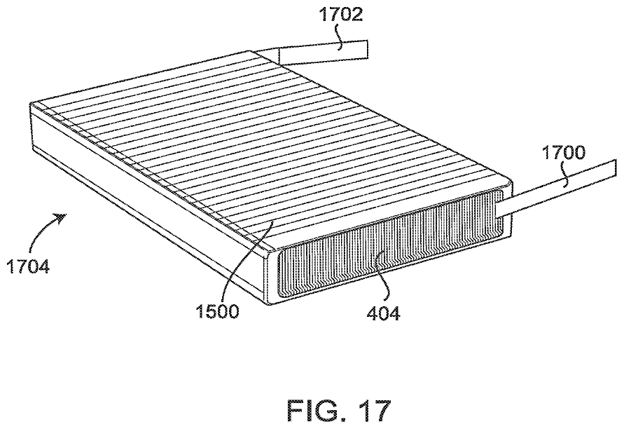

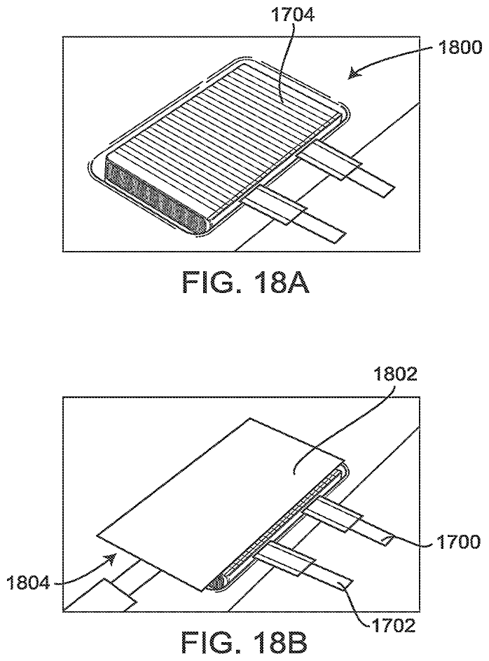

With reference to FIGS. 14-16, the web of electrode material 802 is used to produce a battery. In this embodiment, individual spools of electrode material 1402, 1404, and 1406A and 1406B are unwound and stacked in an alternating configuration including at least one layer of cathode 1402 and anode 1404 separated by separator material 1406. It should be appreciated that the spools of electrode material 1402, 1404, and 1406A and 1406B have been produced as webs of electrode material 802 as described herein. In one suitable embodiment, the spools of electrode material 1402, 1404, 1406A, and 1406B are merged into a multi-layer stack 1500. In this embodiment, the multi-layer stack 1500 includes anode current collector layer 506 in the center, anodically active material layer 508, electrically insulating separator material 500, cathodically active material layer 512 and cathode current conductor layer 510 in a stacked formation. Additional stacked layers may be merged, by alternating layers of spools of anode 1404, separator 1406, and cathode 1402 to form the desired number of layers for multi-layer stack 1500. The layers of multi-layer stack 1500 are aligned using alignment pins 1600 that are driven through fiducial features 602 (FIG. 16B).

In another embodiment, for example for a solid state secondary battery, components of the solid state battery may be stacked (after processing as described herein) in a manner including, in order, a positive electrode current collector, an electrode layer comprising a positive active electrode material, ionic conductor, binder and electronic conductor), a solid state electrolyte and a negative electrode current collector, such as that described in U.S. Pat. No. 9,553,332, referenced above.

In one embodiment, the multi-layer stack 1500 is then placed in a pressurized constraint 1602 having pressure plates 1604, 1606 which apply pressure to the multi-layer stack 1500 in the directions shown by pressure arrows P. The pressure applied to the multi-layer stack 1500 may be adjustable using the user interface 116 to control the pressure P applied by the pressure plates 1604, 1606 to the multi-layer stack 1500. Once a sufficient pressure P has been applied to the multi-layer stack 1500, alignment pins 1600 may be moved in a removal direction R, which causes second perforation 610 to rupture along its length, such that the ablations 404 (electrode tabs) become the outer edges of multi-layer stack 1500, as shown in FIG. 16C.

After the second perforations 610 have ruptured, the multi-layer stack 1500 proceeds to a tab welding station to weld bus bars 1700 and 1702 to the ablations 404 to form stacked cell 1704. Prior to welding, the bus bars 1700, 1702 are placed through the bus bar openings 1608 of the respective electrode. In one embodiment, once the bus bars 1700, 1702 have been placed through the bus bar openings 1608, the ablations 404 are folded down toward bus bars 1700, 1702 respectively, prior to welding. In this embodiment, bus bar 1700 is a copper bus bar and is welded to the ablations 404 (anode tabs) of the anode current collector layer 506, and bus bar 1702 is an aluminum bus bar and is welded to the ablations 404 (cathode tabs) of the cathode current collector layer 510. However, in other embodiments, the bus bars 1700 and 1702 may be any suitable conductive material to allow battery 1804 to function as described herein. The welds may be made using a laser welder, friction welding, ultrasonic welding or any suitable welding method for welding bus bars 1700, 1702 to the ablations 404. In one embodiment, each of the bus bars 1700 and 1702 are in electrical contact with all of the ablations 404 for the anode and cathode, respectively.

Upon formation of the stacked cell 1704, the stacked cell 1704 proceeds to a packaging station 1800. At the packaging station 1800, the stacked cell 1704 is coated with an insulating packaging material, such as a multi-layer aluminum polymer material, plastic, or the like, to form a battery package 1802. In one embodiment, the battery package 1802 is evacuated using a vacuum and filled through an opening (not shown) with an electrolyte material. The insulating packaging material may be sealed around stacked cell 1704 using a heat seal, laser weld, adhesive or any suitable sealing method. The bus bars 1700 and 1702 remain exposed, and are not covered by battery package 1802 to allow a user to connect the bus bars 1700 and 1702 to a device to be powered, or to a battery charger. Once the battery package 1802 is placed on stacked cell 1704, it defines a completed battery 1804. In this embodiment, the completed battery 1804 is a 3-D lithium ion type battery. In other embodiments, the completed battery 1804 may be any battery type suitable for production using the devices and methods described herein.

In one embodiment, each member of the anode population has a bottom, a top, and a longitudinal axis A_{E} (FIG. 7). In one embodiment, the longitudinal axis A_{E} extends in the cross-web direction XWD from the bottom to the top thereof. In an alternative embodiment, the longitudinal axis A_{E} extends in the down-web direction WD from the bottom to the top thereof. In one embodiment, a member of the anode population is formed from the web of base material 104 being anode material 502. Additionally, each member of the anode population has a length (L_{E}) (FIG. 6A) measured along the longitudinal axis (A_{E}) of the electrode, a width (W_{E}) measured in a direction that is orthogonal to the longitudinal axis (A_{E}) (e.g., the down-web direction WD), and a height (H_{E}) (FIG. 6A) measured in a direction that is orthogonal to each of the directions of measurement of the length (L_{E}) and the width (W_{E}).

The length (L_{E}) of the members of the anode population members will vary depending upon the energy storage device and its intended use. In general, however, the members of the anode populations will typically have a length (L_{E}) in the range of about 5 mm to about 500 mm. For example, in one such embodiment, the members of the anode population have a length (L_{E}) of about 10 mm to about 250 mm. By way of further example, in one such embodiment the members of the anode population have a length (L_{E}) of about 25 mm to about 100 mm.

The width (W_{E}) of the members of the anode population will also vary depending upon the energy storage device and its intended use. In general, however, each member of the anode population will typically have a width (W_{E}) within the range of about 0.01 mm to 2.5 mm. For example, in one embodiment, the width (W_{E}) of each member of the anode population will be in the range of about 0.025 mm to about 2 mm. By way of further example, in one embodiment, the width (W_{E}) of each member of the anode population will be in the range of about 0.05 mm to about 1 mm.

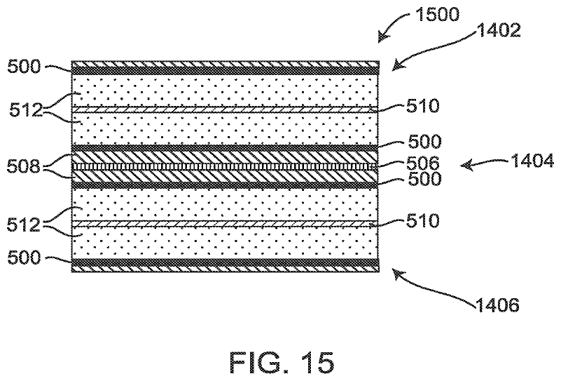

The height (H_{E}) of the members of the anode population will also vary depending upon the energy storage device and its intended use. In general, however, members of the anode population will typically have a height (H_{E}) within the range of about 0.05 mm to about 10 mm. For example, in one embodiment, the height (H_{E}) of each member of the anode population will be in the range of about 0.05 mm to about 5 mm. By way of further example, in one embodiment, the height (H_{E}) of each member of the anode population will be in the range of about 0.1 mm to about 1 mm. According to one embodiment, the members of the anode population include one or more first electrode members having a first height, and one or more second electrode members having a second height that is other than the first. In yet another embodiment, the different heights for the one or more first electrode members and one or more second electrode members may be selected to accommodate a predetermined shape for an electrode assembly (e.g., multi-layer stack 1500 (FIG. 15)), such as an electrode assembly shape having a different heights along one or more of the longitudinal and/or transverse axis, and/or to provide predetermined performance characteristics for the secondary battery.

In general, members of the anode population have a length (L_{E}) that is substantially greater than each of its width (W_{E}) and its height (H_{E}). For example, in one embodiment, the ratio of L_{E} to each of W_{E} and H_{E} is at least 5:1, respectively (that is, the ratio of L_{E} to W_{E} is at least 5:1, respectively and the ratio of L_{E} to H_{E} is at least 5:1, respectively), for each member of the anode population. By way of further example, in one embodiment the ratio of L_{E} to each of W_{E} and H_{E} is at least 10:1. By way of further example, in one embodiment, the ratio of L_{E} to each of W_{E} and H_{E} is at least 15:1. By way of further example, in one embodiment, the ratio of L_{E} to each of W_{E} and H_{E} is at least 20:1, for each member of the anode population.

In one embodiment, the ratio of the height (H_{E}) to the width (W_{E}) of the members of the anode population is at least 0.4:1, respectively. For example, in one embodiment, the ratio of H_{E} to W_{E} will be at least 2:1, respectively, for each member of the anode population. By way of further example, in one embodiment the ratio of H_{E} to W_{E} will be at least 10:1, respectively. By way of further example, in one embodiment the ratio of H_{E} to W_{E} will be at least 20:1, respectively. Typically, however, the ratio of H_{E} to W_{E} will generally be less than 1,000:1, respectively. For example, in one embodiment the ratio of H_{E} to W_{E} will be less than 500:1, respectively. By way of further example, in one embodiment the ratio of H_{E} to W_{E} will be less than 100:1, respectively. By way of further example, in one embodiment the ratio of H_{E} to W_{E} will be less than 10:1, respectively. By way of further example, in one embodiment the ratio of H_{E} to W_{E} will be in the range of about 2:1 to about 100:1, respectively, for each member of the anode population.

In one embodiment, a member of the cathode population is formed from the web of base material 104 being cathode material 504. Referring now to FIG. 6B, each member of the cathode population has a bottom, a top, and a longitudinal axis (A_{CE}) extending from the bottom to the top thereof in the cross-web direction XWD and in a direction generally perpendicular to the direction in which the alternating sequence of negative electrode structures and positive electrode structures progresses. Additionally, each member of the cathode population has a length (L_{CE}) measured along the longitudinal axis (A_{CE}) which is parallel to the cross-web direction XWD, a width (W_{CE}) measured in the down-web direction WD in which the alternating sequence of negative electrode structures and positive electrode structures progresses, and a height (H_{CE}) measured in a direction that is perpendicular to each of the directions of measurement of the length (L_{CE}) and the width (W_{CE}).

The length (L_{CE}) of the members of the cathode population will vary depending upon the energy storage device and its intended use. In general, however, each member of the cathode population will typically have a length (L_{CE}) in the range of about 5 mm to about 500 mm. For example, in one such embodiment, each member of the cathode population has a length (L_{CE}) of about 10 mm to about 250 mm. By way of further example, in one such embodiment each member of the cathode population has a length (L_{CE}) of about 25 mm to about 100 mm.

The width (W_{CE}) of the members of the cathode population will also vary depending upon the energy storage device and its intended use. In general, however, members of the cathode population will typically have a width (W_{CE}) within the range of about 0.01 mm to 2.5 mm. For example, in one embodiment, the width (W_{CE}) of each member of the cathode population will be in the range of about 0.025 mm to about 2 mm. By way of further example, in one embodiment, the width (W_{CE}) of each member of the cathode population will be in the range of about 0.05 mm to about 1 mm.

The height (H_{CE}) of the members of the cathode population will also vary depending upon the energy storage device and its intended use. In general, however, members of the cathode population will typically have a height (H_{CE}) within the range of about 0.05 mm to about 10 mm. For example, in one embodiment, the height (H_{CE}) of each member of the cathode population will be in the range of about 0.05 mm to about 5 mm. By way of further example, in one embodiment, the height (H_{CE}) of each member of the cathode population will be in the range of about 0.1 mm to about 1 mm. According to one embodiment, the members of the cathode population include one or more first cathode members having a first height, and one or more second cathode members having a second height that is other than the first. In yet another embodiment, the different heights for the one or more first cathode members and one or more second cathode members may be selected to accommodate a predetermined shape for an electrode assembly, such as an electrode assembly shape having a different heights along one or more of the longitudinal and/or transverse axis, and/or to provide predetermined performance characteristics for the secondary battery.

In general, each member of the cathode population has a length (L_{CE}) that is substantially greater than width (W_{CE}) and substantially greater than its height (H_{CE}). For example, in one embodiment, the ratio of L_{CE} to each of W_{CE} and H_{CE} is at least 5:1, respectively (that is, the ratio of L_{CE} to W_{CE} is at least 5:1, respectively and the ratio of L_{CE} to H_{CE} is at least 5:1, respectively), for each member of the cathode population. By way of further example, in one embodiment the ratio of L_{CE} to each of W_{CE} and H_{CE} is at least 10:1 for each member of the cathode population. By way of further example, in one embodiment, the ratio of L_{CE} to each of W_{CE} and H_{CE} is at least 15:1 for each member of the cathode population. By way of further example, in one embodiment, the ratio of L_{CE} to each of W_{CE} and H_{CE} is at least 20:1 for each member of the cathode population.

In one embodiment, the ratio of the height (H_{CE}) to the width (W_{CE}) of the members of the cathode population is at least 0.4:1, respectively. For example, in one embodiment, the ratio of H_{CE} to W_{CE} will be at least 2:1, respectively, for each member of the cathode population. By way of further example, in one embodiment the ratio of H_{CE} to W_{CE} will be at least 10:1, respectively, for each member of the cathode population. By way of further example, in one embodiment the ratio of H_{CE} to W_{CE} will be at least 20:1, respectively, for each member of the cathode population. Typically, however, the ratio of H_{CE} to W_{CE} will generally be less than 1,000:1, respectively, for each member of the anode population. For example, in one embodiment the ratio of H_{CE} to W_{CE} will be less than 500:1, respectively, for each member of the cathode population. By way of further example, in one embodiment the ratio of H_{CE} to W_{CE} will be less than 100:1, respectively. By way of further example, in one embodiment the ratio of H_{CE} to W_{CE} will be less than 10:1, respectively. By way of further example, in one embodiment the ratio of H_{CE} to W_{CE} will be in the range of about 2:1 to about 100:1, respectively, for each member of the cathode population.

In one embodiment, anode current collector layer 506 also has an electrical conductance that is substantially greater than the electrical conductance of the anodically active material layer 508. For example, in one embodiment the ratio of the electrical conductance of anode current collector layer 506 to the electrical conductance of the anodically active material layer 508 is at least 100:1 when there is an applied current to store energy in the device or an applied load to discharge the device. By way of further example, in some embodiments the ratio of the electrical conductance of anode current collector layer 506 to the electrical conductance of the anodically active material layer 508 is at least 500:1 when there is an applied current to store energy in the device or an applied load to discharge the device. By way of further example, in some embodiments the ratio of the electrical conductance of anode current collector layer 506 to the electrical conductance of the anodically active material layer 508 is at least 1000:1 when there is an applied current to store energy in the device or an applied load to discharge the device. By way of further example, in some embodiments the ratio of the electrical conductance of anode current collector layer 506 to the electrical conductance of the anodically active material layer 508 is at least 5000:1 when there is an applied current to store energy in the device or an applied load to discharge the device. By way of further example, in some embodiments the ratio of the electrical conductance of anode current collector layer 506 to the electrical conductance of the anodically active material layer 508 is at least 10,000:1 when there is an applied current to store energy in the device or an applied load to discharge the device.

In general, the cathode current collector layer 510 may comprise a metal such as aluminum, carbon, chromium, gold, nickel, NiP, palladium, platinum, rhodium, ruthenium, an alloy of silicon and nickel, titanium, or a combination thereof (see “Current collectors for positive electrodes of lithium-based batteries” by A. H. Whitehead and M. Schreiber, Journal of the Electrochemical Society, 152(11) A2105-A2113 (2005)). By way of further example, in one embodiment, cathode current collector layer 510 comprises gold or an alloy thereof such as gold silicide. By way of further example, in one embodiment, cathode current collector layer 510 comprises nickel or an alloy thereof such as nickel silicide.

The following embodiments are provided to illustrate aspects of the disclosure, although the embodiments are not intended to be limiting and other aspects and/or embodiments may also be provided.

Embodiment 1. A process for delineating a population of electrode structures in a web, the web comprising an electrically conductive layer having opposing front and back surfaces and an electrochemically active material layer on the front surface, the back surface, or on both of the front and back surfaces, the web having a down-web direction and a cross-web direction, the down-web and cross-web directions being orthogonal to each other, the process comprising: moving the web in the down-web direction at a conveying speed while forming a series of weakened tear patterns in the web in the down-web direction, the cross-web direction, or each of the cross-web and down-web directions that delineate members of the electrode structure population without releasing the delineated members from the web, wherein the delineated members are individually bounded, at least in part, by a member of the series of weakened tear patterns that is adapted to facilitate separation of delineated members, individually, from the web by an application of a force, and forming a series of alignment features in the web that are disposed in the cross-web or down-web direction relative to the delineated members, the alignment features being adapted for locating delineated members of the electrode structure population, individually, in the web.

Embodiment 2. A process for delineating a population of electrode structures in a web, the web comprising an electrically conductive layer having opposing front and back surfaces and an electrochemically active material layer on the front surface, the back surface, or on both of the front and back surfaces, the web having a down-web direction and a cross-web direction, the down-web and cross-web directions being orthogonal to each other, the process comprising: moving the web in the down-web direction at a conveying speed; supporting the moving web on a moving support surface, the support surface moving in the down-web direction at the conveying speed, the support surface defining vacuum openings; forming a series of weakened tear patterns in the moving web, the tear patterns formed in the down-web direction, the cross-web direction, or each of the cross-web and down-web directions that delineate members of the electrode structure population without releasing the delineated members from the web, wherein the delineated members are individually bounded, at least in part, by a member of the series of weakened tear patterns that is adapted to facilitate separation of delineated members, individually, from the web by an application of a force, and/or forming a series of alignment features in the web that are disposed in the cross-web or down-web direction relative to the delineated members, the alignment features being adapted for locating delineated members of the electrode structure population, individually, in the web, wherein, during the forming the weakened tear patterns and/or the forming the series of alignment features, the moving web is maintained in a flat state by a vacuum pressure drawn through the vacuum openings of the moving support surface.

Embodiment 3. A process for delineating a population of electrode structures or electrode separator structures in a web, the web comprising a down-web direction, a cross-web direction orthogonal to the down-web direction, and an electrically insulating layer, the process comprising: moving the web in the down-web direction at a conveying speed; supporting the moving web on a moving support surface that moves in the down-web direction at the conveying speed; controlling a portion of the moving web supported on the moving support surface to be laser machined to be within about +/−100 microns of a laser focal point of a laser beam; and laser machining the portion of the moving web in at least one of the cross-web direction and the down web direction to delineate members of the electrode structure or electrode separator structure population in the web without releasing the delineated members from the web and/or to form an alignment feature in the web that is adapted for locating each delineated member of the electrode structure or electrode separator structure population in the web.

Embodiment 4. A process for delineating a population of electrode structures in a web, the web comprising a down-web direction and a cross-web direction orthogonal to the down-web direction, the process comprising: moving the web in a down-web direction at a conveying speed; supporting the moving web on a moving support surface that moves in the down-web direction at the conveying speed; machining the web in the cross-web and down-web directions to form a discontinuous weakened portion to delineate members of the electrode structure population in the web without releasing the delineated members from the web, the machined web having a strength of 10% to 75% of the strength of unmachined web in the web direction.

Embodiment 5. A process for delineating a population of electrode structures in a web, the web comprising a down-web direction, a cross-web direction orthogonal to the down-web direction, an electrochemically active layer, and an electrically conductive layer, the process comprising: moving the web in a down-web direction at a conveying speed; supporting the moving web on a moving support surface that moves in the down-web direction at the conveying speed; and laser machining the moving web in at least the cross-web direction to delineate members of the electrode structure population in the web without releasing the delineated members from the web and/or to form an alignment feature in the moving web that is adapted for locating each delineated member of the electrode structure population in the web.

Embodiment 6. A process for delineating a population of electrode separator structures in a web, the web comprising a down-web direction, a cross-web direction orthogonal to the down-web direction, and an electrically insulating layer, the process comprising: moving the web in the down-web direction at a conveying speed; supporting the moving web on a moving support surface that moves in the down-web direction at the conveying speed; laser machining the web in at least the cross-web direction to delineate members of the electrode separator structure population in the web without releasing the delineated members from the web and/or to form an alignment feature in the web that is adapted for locating each delineated member of the electrode structure population in the web.

Embodiment 7. A process for delineating a population of electrode structures in a web, the web comprising a down-web direction, a cross-web direction orthogonal to the down-web direction, an electrochemically active layer, and an electrically conductive layer, the process comprising: feeding the web to a cutting station at a conveying speed such that the web is brought into moving engagement with a support surface moving at the conveying speed; cutting the moving web in at least the cross-web direction at the cutting station to delineate members of the electrode structure population in the web without releasing the delineated members from the web; and cutting alignment features in the moving web that are adapted for locating each delineated member of the electrode structure population in the web.

Embodiment 8. A process for delineating a population of electrode structures in a web, the web comprising a down-web direction, a cross-web direction orthogonal to the down-web direction, an electrochemically active layer, and an electrically conductive layer, the process comprising: feeding the web to a laser cutting system at a conveying speed such that the web is brought into moving engagement with a support surface moving at the conveying speed; cutting alignment features into the moving web using the laser cutting system; establishing a location of the moving web using at least one of the alignment features; and performing at least one of a cut action and an ablate action on the moving web based on the established location.

Embodiment 9. A process for delineating a population of electrode structures in a web, the web comprising a down-web direction, a cross-web direction orthogonal to the down-web direction, an electrochemically active layer, and an electrically conductive layer, the process comprising: moving the web in the down-web direction at a conveying speed; laser machining the moving web in at least the cross-web direction to delineate members of the electrode structure population in the web by forming a discontinuous weakened portion defining an outer boundary of each delineated member, without releasing the delineated members from the moving web; and forming an alignment feature in the moving web that is adapted for locating each delineated member of the electrode structure population in the web.

Embodiment 10. A process for delineating a population of electrode structures in a web, the web comprising a down-web direction and a cross-web direction orthogonal to the down-web direction, the process comprising: moving the web in the down-web direction at a conveying speed; and machining the moving web in the cross-web and down-web directions to form a discontinuous weakened portion to delineate members of the electrode structure population in the web without releasing the delineated members from the web, the machined web having a strength of 5% to 30% of the strength of the unmachined web in the cross-web direction.

Embodiment 11. A process for delineating a population of electrode structures in a web, the web comprising a down-web direction, a cross-web direction orthogonal to the down-web direction, and at least one of a solid state electrolyte, a negative electrode current collector, a positive electrode current collector and an positive electrode active material, the process comprising: feeding the web to a laser cutting system at a conveying speed such that the web is brought into moving engagement with a support surface moving at the conveying speed; cutting alignment features into the moving web using the laser cutting system; establishing a location of the moving web using at least one of the alignment features; and performing at least one of a cut action and an ablate action on the moving web based on the established location.

Embodiment 12. A process for machining a web made of electrode material, the process comprising: moving the web in a down-web direction at a conveying speed; controlling a work platform extending between first and second ends of a web path to move continuously at the conveying speed from the first end of the web path to the second end of the web path; engaging the continuously moving work platform with the moving web at the first end of the web path; machining the moving web at a machining location between the first and second ends of the web path; removing debris from the moving work platform at or downstream from the machining location; and disengaging the moving web from the moving work platform at the second end of the web path.

Embodiment 13. An apparatus for machining a web made of electrode material, the web having a down-web direction and a cross-web direction, the down-web and cross-web directions being orthogonal to each other, the apparatus configured to perform the process of any one of the preceding embodiments, the apparatus comprising: a track defining a web path and an offload path, the track extending continuously between the web path and the offload path; a plurality of supports operatively coupled to the track and moveable continuously along the web path and the offload path, the track being operable to control a conveying speed of each support of the plurality of supports along the web path, each support comprising a work surface that engages with the web at a first end of the web path to convey the web in the down-web direction at the conveying speed along the web path between the first end and a second end of the web path, the web being disengaged from the work surface at the second end of the web path; and a machining device located between the first end and the second end of the web path, the machining device being operable to act on the web as the web is conveyed in the down-web direction at the conveying speed along the web path.

Embodiment 14. An apparatus for machining a web made of electrode material, the web having a down-web direction and a cross-web direction, the down-web and cross-web directions being orthogonal to each other, the apparatus configured to perform the process of any one of the preceding embodiments, the apparatus comprising: a track defining a web path extending in the down-web direction between a first end and a second end; a work platform operably coupled to the track, the work platform extending between the first and second ends of the web path, the track being operable to continuously move the work platform from the first end of the web path to the second end of the web path at a conveying speed, wherein the work platform engages with the web at the first end of the web path and disengages from the work surface at the second end of the web path to convey the web along the web path at the conveying speed; a machining device located between the first and second ends of the web path, the machining device being operable to act on the web as the web is conveyed at the conveying speed along the web path; and a vacuum chute to remove debris from the continuously moving work platform.

Embodiment 15. The process or apparatus of any preceding Embodiment wherein the series of weakened tear patterns are formed with a laser.

Embodiment 16. The process or apparatus of any preceding Embodiment, wherein the series of alignment features are formed with a laser.

Embodiment 17. The process or apparatus of any preceding Embodiment, wherein the series of weakened tear patterns, the series of alignment features, or the series of weakened tear patterns and the series of alignment features are formed with a laser.

Embodiment 18. The process or apparatus of any preceding Embodiment, wherein the laser has a laser power within a range of from 10 watts to 5,000 watts, is a fiber laser, is capable of laser pulse width types of one or more of continuous wave (cw), microsecond (ps), nanosecond (ns), picosecond (ps) and femtosecond (fs) pulse types or combinations thereof.

Embodiment 19. The process or apparatus of any preceding Embodiment, wherein the electrochemically active material layer is on only one of the front and back surfaces of the electrically conductive layer.

Embodiment 20. The process or apparatus of any preceding Embodiment, wherein the electrochemically active material layer is on both of the front and back surfaces of the electrically conductive layer.

Embodiment 21. The process or apparatus of any preceding Embodiment, wherein the delineated members of the electrode structure population have a length, L_{E}, and a height, H_{E}, wherein: (i) L_{E} is measured in the cross-web direction and H_{E} is measured in the down-web direction or (ii) L_{E} is measured in the down-web direction and H_{E} is measured in the cross-web direction.

Embodiment 22. The process or apparatus of any preceding Embodiment, wherein the delineated members of the electrode structure population have a length, L_{E}, and a height, H_{E}, wherein L_{E} is measured in the cross-web direction and H_{E} is measured in the down-web direction.

Embodiment 23. The process or apparatus of any preceding Embodiment, wherein the delineated members of the electrode structure population have a length, L_{E}, and a height, H_{E}, wherein L_{E} is measured in the down-web direction and H_{E} is measured in the cross-web direction.

Embodiment 24. The process or apparatus of any preceding Embodiment, wherein the delineated members of the electrode structure population have a width, W_{E}, measured in a direction that is orthogonal to the front and back surfaces of the web and to the down-web and cross-web directions.

Embodiment 25. The process or apparatus of any preceding Embodiment, wherein a ratio of L_{E} to each of W_{E} and H_{E} is at least 5:1 (that is, the ratio of L_{E} to W_{E} is at least 5:1, respectively and the ratio of L_{E} to H_{E} is at least 5:1, respectively).

Embodiment 26. The process or apparatus of any preceding Embodiment, wherein the ratio of L_{E} to each of W_{E} and H_{E} is at least 10:1 (that is, the ratio of L_{E} to W_{E} is at least 10:1, respectively and the ratio of L_{E} to H_{E} is at least 10:1, respectively).

Embodiment 27. The process or apparatus of any preceding Embodiment, wherein the ratio of L_{E} to each of W_{E} and H_{E} is at least 15:1 (that is, the ratio of L_{E} to W_{E} is at least 15:1, respectively and the ratio of L_{E} to H_{E} is at least 15:1, respectively).

Embodiment 28. The process or apparatus of any preceding Embodiment, wherein the ratio of L_{E} to each of W_{E} and H_{E} is at least 20:1 (that is, the ratio of L_{E} to W_{E} is at least 20:1, respectively and the ratio of L_{E} to H_{E} is at least 20:1, respectively).

Embodiment 29. The process or apparatus of any preceding Embodiment, wherein the ratio of H_{E} to W_{E} is at least 0.4:1, respectively.

Embodiment 30. The process or apparatus of any preceding Embodiment, wherein the ratio of H_{E} to W_{E} is at least 2:1, respectively.

Embodiment 31. The process or apparatus of any preceding Embodiment, wherein the ratio of H_{E} to W_{E} is at least 10:1, respectively.

Embodiment 32. The process or apparatus of any preceding Embodiment, wherein the ratio of H_{E} to W_{E} is at least 20:1, respectively.

Embodiment 33. The process or apparatus of any preceding Embodiment, wherein the ratio of H_{E} to W_{E} is less than 1,000:1, respectively.

Embodiment 34. The process or apparatus of any preceding Embodiment, wherein the ratio of H_{E} to W_{E} is less than 500:1, respectively.

Embodiment 35. The process or apparatus of any preceding Embodiment, wherein the ratio of H_{E} to W_{E} is less than 100:1, respectively.

Embodiment 36. The process or apparatus of any preceding Embodiment, wherein the ratio of H_{E} to W_{E} is less than 10:1, respectively.

Embodiment 37. The process or apparatus of any preceding Embodiment, wherein the ratio of H_{E} to W_{E} is within a range of about 2:1 to about 100:1, respectively.

Embodiment 38. The process or apparatus of any preceding Embodiment, wherein L_{E} is within a range of about 5 mm to about 500 mm.

Embodiment 39. The process or apparatus of any preceding Embodiment, wherein L_{E} is within a range of about 10 mm to about 250 mm.

Embodiment 40. The process or apparatus of any preceding Embodiment, wherein L_{E} is within a range of about 25 mm to about 100 mm.

Embodiment 41. The process or apparatus of any preceding Embodiment, wherein W_{E} is within a range of about 0.01 mm to 2.5 mm.

Embodiment 42. The process or apparatus of any preceding Embodiment, wherein W_{E} is within a range of about 0.025 mm to about 2 mm.

Embodiment 43. The process or apparatus of any preceding Embodiment, wherein W_{E} is within a range of about 0.05 mm to about 1 mm.

Embodiment 44. The process or apparatus of any preceding Embodiment, wherein H_{E} is within a range of about 0.05 mm to about 10 mm.

Embodiment 45. The process or apparatus of any preceding Embodiment, wherein H_{E} is within a range of about 0.05 mm to about 5 mm.

Embodiment 46. The process or apparatus of any preceding Embodiment, wherein H_{E} is within a range of about 0.1 mm to about 1 mm.

Embodiment 47. The process or apparatus of any preceding Embodiment, wherein the electrically conductive layer has an electrical conductivity of at least 10³ Siemens/cm.

Embodiment 48. The process or apparatus of any preceding Embodiment, wherein the electrically conductive layer has an electrical conductivity of at least about 10⁴ Siemens/cm.

Embodiment 49. The process or apparatus of any preceding Embodiment, wherein the electrically conductive layer has an electrical conductivity of at least about 10⁴ Siemens/cm.

Embodiment 50. The process or apparatus of any preceding Embodiment, wherein the electrically conductive layer comprises a material suitable for use as a positive electrode current collector layer.

Embodiment 51. The process or apparatus of any preceding Embodiment, wherein the electrically conductive layer comprises aluminum, carbon, chromium, gold, nickel, nickel phosphorous (NiP), palladium, platinum, rhodium, ruthenium, titanium, an alloy of silicon and nickel (NiSi), or a combination thereof.

Embodiment 52. The process or apparatus of any preceding Embodiment, wherein the electrochemically active material layer comprises a cathodically active material.

Embodiment 53. The process or apparatus of any preceding Embodiment, wherein the electrochemically active material layer(s) comprise a transition metal oxide, a transition metal sulfide, a transition metal nitride, a lithium-transition metal oxide, a lithium-transition metal sulfide, or a lithium-transition metal nitride.

Embodiment 54. The process or apparatus of any preceding Embodiment, wherein the electrochemically active material layer(s) comprise a transition metal oxide, a transition metal sulfide, or a transition metal nitride wherein the transition metal has a d-shell or f-shell.

Embodiment 55. The process or apparatus of any preceding Embodiment, wherein the electrochemically active material layer(s) comprise Sc, Y, a lanthanoid, an actinoid, Ti, Zr, Hf, V, Nb, Ta, Cr, Mo, W, Mn, Tc, Re, Fe, Ru, Os, Co, Rh, Ir, Ni, Pb, Pt, Cu, Ag, or Au.

Embodiment 56. The process or apparatus of any preceding Embodiment, wherein the electrochemically active material layer(s) comprise LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co_{z})O₂, and combinations thereof.

Embodiment 57. The process or apparatus of any preceding Embodiment, wherein the electrically conductive layer comprises a material suitable for use as a negative electrode current collector layer.

Embodiment 58. The process or apparatus of any preceding Embodiment, wherein the electrically conductive layer comprises copper, nickel, cobalt, titanium, or tungsten, or an alloy thereof.

Embodiment 59. The process or apparatus of any of preceding Embodiment wherein the electrochemically active material layer(s) comprise an anodically active material.

Embodiment 60. The process or apparatus of any of preceding Embodiment wherein the electrochemically active material layer(s) comprise graphite, a soft or hard carbon, or graphene.

Embodiment 61. The process or apparatus of any preceding Embodiment wherein the electrochemically active material layer(s) comprise single-walled or multi-walled carbon nanotubes.

Embodiment 62. The process or apparatus of any preceding Embodiment wherein the electrochemically active material layer(s) comprise single-walled carbon nanotubes.

Embodiment 63. The process or apparatus of any preceding Embodiment wherein the electrochemically active material layer(s) comprise a metal, a semi-metal, an alloy, or an oxide or nitride thereof capable of forming an alloy with lithium.

Embodiment 64. The process or apparatus of any preceding Embodiment wherein the electrochemically active material layer(s) comprise graphite, tin, lead, magnesium, aluminum, boron, gallium, silicon, a Si/C composite, a Si/graphite blend, silicon oxide (SiOx), porous Si, intermetallic Si alloys, indium, zirconium, germanium, bismuth, cadmium, antimony, silver, zinc, arsenic, hafnium, yttrium, lithium, sodium, lithium titanate, palladium, or a combination thereof.

Embodiment 65. The process or apparatus of any preceding Embodiment wherein the electrochemically active material layer(s) comprise aluminum, tin, or silicon, or an oxide thereof, a nitride thereof, a fluoride thereof, or alloy thereof.

Embodiment 66. The process or apparatus of any preceding Embodiment wherein the electrochemically active material layer(s) comprise silicon or an alloy or oxide thereof.

Embodiment 67. The process or apparatus of any preceding Embodiment wherein the electrically conductive layer comprises a material suitable for use as a negative electrode current collector layer, the electrochemically active material layer(s) comprises an anodically active material and the electrically conductive layer has an electrical conductance that is substantially greater than the electrical conductance of the anodically active material layer.

Embodiment 68. The process or apparatus of any preceding Embodiment wherein a ratio of the electrical conductance of the electrically conductive layer to the electrical conductance of the anodically active material layer is at least 100:1.

Embodiment 69. The process or apparatus of any preceding Embodiment wherein a ratio of the electrical conductance of the electrically conductive layer to the electrical conductance of the anodically active material layer is at least 500:1.

Embodiment 70. The process or apparatus of any preceding Embodiment wherein a ratio of the electrical conductance of the electrically conductive layer to the electrical conductance of the anodically active material layer is at least 1,000:1.

Embodiment 71. The process or apparatus of any preceding Embodiment wherein a ratio of the electrical conductance of the electrically conductive layer to the electrical conductance of the anodically active material layer is at least 5,000:1.

Embodiment 72. The process or apparatus of any preceding Embodiment wherein a ratio of the electrical conductance of the electrically conductive layer to the electrical conductance of the anodically active material layer is at least 10,000:1.

Embodiment 73. The process or apparatus of any preceding Embodiment, wherein the web is a laminate comprising an electrochemically active layer and an electrically conductive layer.

Embodiment 74. The process or apparatus of any preceding Embodiment, wherein the electrochemically active layer comprises an anodically active material.

Embodiment 75. The process or apparatus of any preceding Embodiment, wherein the electrochemically active layer comprises a cathodically active material.

Embodiment 76. The process or apparatus of any preceding Embodiment, wherein the laser machining comprises forming a plurality of cuts and perforations through the web.

Embodiment 77. The process or apparatus of any preceding Embodiment, wherein the machined web has a strength of 10% to 75% of a strength of unmachined web in the web direction.

Embodiment 78. The process or apparatus of any preceding Embodiment, wherein the machined web has a strength of 5% to 30% of the strength of an unmachined web in the cross-web direction.

Embodiment 79. The process or apparatus of any preceding Embodiment, wherein the alignment feature comprises a through-hole extending through the web.

Embodiment 80. The process or apparatus of any preceding Embodiment, wherein the laser machining comprises forming a series of outer perforations and a series of inner perforations, the outer perforations having a lower rupture strength than the inner perforations.

Embodiment 81. The process or apparatus of any preceding Embodiment, wherein the laser machining comprises ablating an electrode tab area from each delineated electrode.

Embodiment 82. The process or apparatus of any preceding Embodiment, further comprising laser machining the web in the down-web direction.

Embodiment 83. The process or apparatus of any preceding Embodiment, further comprising using information related to the alignment feature to position a laser beam during the laser machining of the web.

Embodiment 84. The process or apparatus of any preceding Embodiment, wherein the laser machining comprises controlling a first laser device to laser machine the web in the cross-web direction and controlling a second laser device to laser machine the web in the down-web direction.

Embodiment 85. The process or apparatus of any preceding Embodiment, further comprising applying a vacuum to the web during the laser machining of the web.

Embodiment 86. The process or apparatus of any preceding Embodiment, further comprising using a sensor to detect defects in the delineated members.

Embodiment 87. The process or apparatus of any preceding Embodiment, further comprising using a marking device to mark the web in a manner to indicate a detected defect in the delineated member.

Embodiment 88. The process or apparatus of any preceding Embodiment, further comprising laser machining a tie bar between groupings of the delineated members.

Embodiment 89. The process or apparatus of any preceding Embodiment, wherein the tie bar is defined by laser machined cuts in the cross-web direction.

Embodiment 90. The process or apparatus of any preceding Embodiment, further comprising applying a tension to the web in the cross-web direction prior to the laser machining.

Embodiment 91. The process or apparatus of any preceding Embodiment, wherein the alignment features are formed at a location distal to the delineated members in the cross-web direction.

Embodiment 92. The process or apparatus of any preceding Embodiment, further comprising leaving an unmachined portion of the web between the alignment features and an outermost edge of the web in the cross-web direction.

Embodiment 93. The process or apparatus of any preceding Embodiment, wherein the unmachined portion extends across an entire length of the web in the web direction.

Embodiment 94. The process or apparatus of any preceding Embodiment, further comprising contacting a rotating brush against the web after the laser machining.

Embodiment 95. The process or apparatus of any preceding Embodiment, wherein the laser machining process occurs while the web moves in the down-web direction.

Embodiment 96. The process or apparatus of any preceding Embodiment, wherein a laser beam is controlled to account for a speed of travel of the web in the down-web direction during the laser machining.

Embodiment 97. The process or apparatus of any preceding Embodiment, further comprising controlling the tension of the web in the down-web direction during the laser machining.

Embodiment 98. The process or apparatus of any preceding Embodiment, further comprising winding the laser machined web with an interleaf layer.

Embodiment 99. The process or apparatus of any preceding Embodiment, further comprising conveying the web in the down-web direction after the laser machining without releasing the delineated members from the web.

Embodiment 100. The process or apparatus of any preceding Embodiment, wherein there is a one to one ratio of alignment features to delineated members.

Embodiment 101. The process or apparatus of any preceding Embodiment, wherein the weakened portion comprises a series of through cuts or perforations.

Embodiment 102. The process of any preceding Embodiment, further comprising pressure-balancing the web during the forming of the discontinuous weakened portion.

Embodiment 103. The process of Embodiment 102, wherein the pressure-balancing involves application of a fluid flow across the web.

Embodiment 104. The process Embodiment 102 or 103, wherein the pressure-balancing comprises applying a fluid flow across opposing sides of the web.

Embodiment 105. The process or apparatus of any preceding Embodiment, wherein the alignment feature is formed prior to the laser machining.

Embodiment 106. The process or apparatus of any preceding Embodiment, wherein the alignment feature is used to aid in the forming of the discontinuous weakened portions.

Embodiment 107. The process or apparatus of any preceding Embodiment, wherein the support surface comprises aluminum and the support surface dissipates thermal energy from the laser machining process.

Embodiment 108. The process of apparatus of any preceding Embodiment, wherein the laser machining is performed on a portion of the web located over an opening of a support surface.

Embodiment 109. The process or apparatus of any preceding Embodiment, wherein the controlling a portion of the web comprises controlling the web in a vertical axis direction substantially parallel to the laser beam.

Embodiment 110. The process or apparatus of any preceding Embodiment, wherein the support surface comprises a plurality of openings, and the forming the weakened tear patterns and the forming the series of alignment features is performed on respective portions of the web located over different ones of the plurality of openings.

Embodiment 111. The process or apparatus of any preceding Embodiment, wherein controlling the tension of the web comprises maintaining a tension on the web of 500 gram force or less.

Embodiment 112. The process or apparatus of any preceding Embodiment, wherein tension in the web is controlled substantially by vacuum pressure drawn on the web.

Embodiment 113. The process or apparatus of any preceding Embodiment, wherein the conveying speed is from 10 mm/sec to about 2000 mm/sec.

Embodiment 114. The apparatus of any preceding Embodiment, further comprising a vacuum chute to remove debris from the work surface of each support at or downstream from the machining device as the support moves along the track.

Embodiment 115. The apparatus of any preceding Embodiment, wherein the vacuum chute is located below the work surface as the support moves along the web path.

Embodiment 116. The apparatus of any preceding Embodiment, further comprising an inline cleaning device located downstream from the second end of the web path and operable to remove debris from the work surface as the support moves along the offload path.

Embodiment 117. The apparatus of any preceding Embodiment, further comprising a vacuum rail extending between the first and second ends of the web path and operable to draw a vacuum pressure on the work surface of each support as the support moves along the web path and maintain engagement between the web and the work surface along the web path.

Embodiment 118. The apparatus of any preceding Embodiment, wherein the track is operable to control an offload speed of each support along the offload path, the offload speed being greater than the conveying speed.

Embodiment 119. The apparatus of any preceding Embodiment, wherein the track is operable to control the conveying speed and the offload speed of each support such that a continuous, moving work platform is defined by adjacent work surfaces of a subset of the plurality of supports and extends from the first end of the web path to the second end of the web path during movement of the plurality of supports along the track.

Embodiment 120. The apparatus of any preceding Embodiment, wherein the machining device is operable to laser machine the web in the cross-web direction as the web is conveyed in the down-web direction.

Embodiment 121. The apparatus of any preceding Embodiment, wherein the work surface of each support is made of a thermally conductive material to dissipate heat generated by laser machining the web.

Embodiment 122. The apparatus of any preceding Embodiment, wherein the machining device is operable to emit a laser beam and control the laser beam to travel at an angle relative to the cross-web direction based on the conveying speed.

Embodiment 123. The apparatus of any preceding Embodiment, comprising a vacuum chute located below the work platform and operable to draw a vacuum pressure through openings defined in the work platform that pass over the vacuum chute and remove debris from the work platform.

Embodiment 124. The apparatus of any preceding Embodiment, comprising a vacuum rail extending between the first and second ends of the web path and operable to draw a vacuum pressure on the work platform to maintain engagement between the web and the work platform along the web path.

Embodiment 125. The apparatus of any preceding Embodiment, wherein the vacuum rail and the vacuum chute are fluidly connected with a common vacuum.

Embodiment 126. The apparatus of any preceding Embodiment, wherein the continuously moving work platform is defined by adjacent work surfaces of a plurality of supports operatively coupled to the track and moveable continuously along the web path at the conveying speed and an offload path of the track at an offload speed that is greater than the conveying speed.

Embodiment 127. The process or apparatus of any preceding Embodiment, wherein the support surface is defined by adjacent work surfaces of a plurality of supports operatively coupled to the track and moveable continuously along the web path at the conveying speed and an offload path of the track at an offload speed that is greater than the conveying speed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus for machining a web made of electrode material, the web having a down-web direction and a cross-web direction, the down-web and cross-web directions being orthogonal to each other, the apparatus comprising:
a track defining a web path and an offload path, the track extending continuously between the web path and the offload path;
a plurality of supports operatively coupled to the track and moveable continuously along the web path and the offload path, the track being operable to control a conveying speed of each support of the plurality of supports along the web path, each support comprising a work surface that engages with the web at a first end of the web path to convey the web in the down-web direction at the conveying speed along the web path between the first end and a second end of the web path, the web being disengaged from the work surface at the second end of the web path; and
a machining device located between the first end and the second end of the web path, the machining device being operable to act on the web as the web is conveyed in the down-web direction at the conveying speed along the web path.

2. The apparatus of claim 1, further comprising a vacuum chute to remove debris from the work surface of each support at or downstream from the machining device as the support moves along the track.

3. The apparatus of claim 2, wherein the vacuum chute is located below the work surface as the support moves along the web path.

4. The apparatus of claim 3, further comprising an inline cleaning device located downstream from the second end of the web path and operable to remove debris from the work surface as the support moves along the offload path.

5. The apparatus of claim 1, further comprising a vacuum rail extending between the first and second ends of the web path and operable to draw a vacuum pressure on the work surface of each support as the support moves along the web path and maintain engagement between the web and the work surface along the web path.

6. The apparatus of claim 1, wherein the track is operable to control an offload speed of each support along the offload path, the offload speed being greater than the conveying speed.

7. The apparatus of claim 6, wherein the track is operable to control the conveying speed and the offload speed of each support such that a continuous, moving work platform is defined by adjacent work surfaces of a subset of the plurality of supports and extends from the first end of the web path to the second end of the web path during movement of the plurality of supports along the track.

8. The apparatus of claim 1, wherein the machining device is operable to laser machine the web in the cross-web direction as the web is conveyed in the down-web direction.

9. The apparatus of claim 8, wherein the work surface of each support is made of a thermally conductive material to dissipate heat generated by laser machining the web.

10. The apparatus of claim 8, wherein the machining device is operable to emit a laser beam and control the laser beam to travel at an angle relative to the cross-web direction based on the conveying speed.

11. An apparatus for machining a web made of electrode material, the web having a down-web direction and a cross-web direction, the down-web and cross-web directions being orthogonal to each other, the apparatus comprising:
a track defining a web path extending in the down-web direction between a first end and a second end;
a work platform operably coupled to the track, the work platform extending between the first and second ends of the web path, the track being operable to continuously move the work platform from the first end of the web path to the second end of the web path at a conveying speed, wherein the work platform engages with the web at the first end of the web path and disengages from the work surface at the second end of the web path to convey the web along the web path at the conveying speed;
a machining device located between the first and second ends of the web path, the machining device being operable to act on the web as the web is conveyed at the conveying speed along the web path; and
a vacuum chute to remove debris from the continuously moving work platform.

12. The apparatus of claim 11, wherein the vacuum chute is located below the work platform and is operable to draw a vacuum pressure through openings defined in the work platform that pass over the vacuum chute and remove debris from the work platform.

13. The apparatus of claim 11, further comprising a vacuum rail extending between the first and second ends of the web path and operable to draw a vacuum pressure on the work platform to maintain engagement between the web and the work platform along the web path.

14. The apparatus of claim 13, wherein the vacuum rail and the vacuum chute are fluidly connected with a common vacuum.

15. The apparatus of claim 11, wherein the machining device is operable to laser machine the web in the cross-web direction as the web is conveyed in the down-web direction.

16. The apparatus of claim 14, wherein the machining device is operable to emit a laser beam and control the laser beam to travel at an angle relative to the cross-web direction based on the conveying speed.

17. The apparatus of claim 11, wherein the continuously moving work platform is defined by adjacent work surfaces of a plurality of supports operatively coupled to the track and moveable continuously along the web path at the conveying speed and an offload path of the track at an offload speed that is greater than the conveying speed.

18. A process for machining a web made of electrode material, the process comprising:
moving the web in a down-web direction at a conveying speed;
controlling a work platform extending between first and second ends of a web path to move continuously at the conveying speed from the first end of the web path to the second end of the web path;
engaging the continuously moving work platform with the moving web at the first end of the web path;
machining the moving web at a machining location between the first and second ends of the web path;
removing debris from the moving work platform at or downstream from the machining location; and
disengaging the moving web from the moving work platform at the second end of the web path.

19. The process of claim 18, further comprising drawing a vacuum pressure on the continuously moving work platform to maintain engagement with the moving web along the web path.

20. The process of claim 18, wherein machining the moving web comprises laser machining the moving web in a cross-web direction orthogonal to the down-web direction with a laser beam that is controlled to travel at an angle relative to the cross-web direction based on the conveying speed.
